(19) United States
(12) Patent Application Publication
(10) Pub. No.: US 2026/0153879 A1
(43) Pub. Date: Jun. 4, 2026

(54) CONTROL METHOD FOR CLEANING DEVICE, AND CLEANING DEVICE

(71) Applicant: XINGMAI INNOVATION TECHNOLOGY (SUZHOU) CO., LTD., Suzhou (CN)

(72) Inventors: Shilei ZHANG, Suzhou (CN); Shengle WANG, Suzhou (CN)

(21) Appl. No.: 19/079,095

(22) Filed: Mar. 13, 2025

Related U.S. Application Data
(63) Continuation of application No. PCT/CN2024/089380, filed on Apr. 23, 2024.

(30) Foreign Application Priority Data
Apr. 27, 2023 (CN) 202310473863.X
May 22, 2023 (CN) 202310580463.9
Jun. 6, 2023 (CN) 202310665144.8
Jun. 15, 2023 (CN) 202310714283.5
Jun. 27, 2023 (CN) 202310768696.1
Jul. 13, 2023 (CN) 202310862067.5
Aug. 10, 2023 (CN) 202311006743.5
Aug. 17, 2023 (CN) 202311041067.5
Sep. 13, 2023 (CN) 202311183922.6

(51) Int. Cl. G05D 1/648; E04H 4/16; G05D 105/10; G05D 107/00

(52) U.S. Cl. CPC G05D 1/648; E04H 4/1654; G05D 2105/10; G05D 2107/29

(57) ABSTRACT

This application discloses a method for controlling a cleaning device to clean a wall, including: controlling the cleaning device to perform cleaning along a first cleaning path and to move along the first cleaning path for a first target preset distance in a first direction or a second direction to a path switching position, where the first direction is a direction from the bottom of a target water region to a water surface of the target water region, and the second direction is a direction from the water surface of the target water region to the bottom of the target water region; controlling the cleaning device to move from the path switching position along a third path to a starting position of a second cleaning path; and controlling the cleaning device to move along the second cleaning path in the first direction or the second direction.

### CROSS-REFERENCE TO RELATED APPLICATIONS

This application is a continuation-in-part of International Patent Application No. PCT/CN2024/089380, filed on Apr. 23, 2024, which claims priority to: Chinese Patent Application No. 202311006743.5, filed with the China National Intellectual Property Administration on Aug. 10, 2023 and entitled “METHOD FOR CONSTRUCTING MAP OF WATER SURFACE, STORAGE MEDIUM, AND POOL ROBOT”; Chinese Patent Application No. 202310862067.5, filed with the China National Intellectual Property Administration on Jul. 13, 2023 and entitled “TARGET MAP CONSTRUCTING METHOD, STORAGE MEDIUM, AND POOL ROBOT”; Chinese Patent Application No. 202311183922.6, filed with the China National Intellectual Property Administration on Sep. 13, 2023 and entitled “METHOD FOR GENERATING MAP OF POOL, STORAGE MEDIUM, AND POOL ROBOT”; Chinese Patent Application No. 202310580463.9, filed with the China National Intellectual Property Administration on May 22, 2023 and entitled “POSE UPDATING METHOD AND APPARATUS, STORAGE MEDIUM, AND POOL ROBOT”; Chinese Patent Application No. 202310768696.1, filed with the China National Intellectual Property Administration on Jun. 27, 2023 and entitled “METHOD FOR CONTROLLING ROBOT TO MOVE”; Chinese Patent Application No. 202310665144.8, filed with the China National Intellectual Property Administration on Jun. 6, 2023 and entitled “METHOD FOR CONTROLLING ROBOT TO MOVE”; Chinese Patent Application No. 202310714283.5, filed with the China National Intellectual Property Administration on Jun. 15, 2023 and entitled “POOL ROBOT CONTROL METHOD AND STORAGE MEDIUM”; Chinese Patent Application No. 202310473863.X, filed with the China National Intellectual Property Administration on Apr. 27, 2023 and entitled “ROBOT CONTROL METHOD AND APPARATUS”; and Chinese Patent Application No. 202311041067.5, filed with the China National Intellectual Property Administration on Aug. 17, 2023 and entitled “ROBOT CONTROL METHOD”, all of which are hereby incorporated by reference herein.

### TECHNICAL FIELD

This application relates to the field of artificial intelligence technologies, and in particular, to a method for controlling a cleaning device to clean a wall.

### BACKGROUND

Due to low costs and an extremely low error rate, cleaning devices are gradually replacing much labor of people. An existing cleaning device operating in water can perform cleaning in the water. However, the cleaning device also has certain problems. Most cleaning devices move randomly during operation, leading to low efficiency in performing specific tasks, for example, cleaning a wall.

### SUMMARY

This application provides a method for controlling a cleaning device to clean a wall, to resolve a problem of low random cleaning efficiency of the cleaning device in a related technology, thereby improving operating efficiency of the cleaning device.

To resolve the foregoing technical problem, a first aspect of this application provides a method for controlling a cleaning device to clean a wall. The cleaning device moves in a target water region. The method includes: when the cleaning device cleans a first wall of the target water region, controlling the cleaning device to perform cleaning along a first cleaning path; controlling the cleaning device to move along the first cleaning path for a first target preset distance in a first direction or a second direction to a path switching position, where the first direction is a direction from the bottom of the target water region to a water surface of the target water region, and the second direction is a direction from the water surface of the target water region to the bottom of the target water region; controlling the cleaning device to move from the path switching position along a third path for preset duration or a second target preset distance to a starting position of a second cleaning path; and controlling the cleaning device to move along the second cleaning path in the first direction or the second direction to perform cleaning along the second cleaning path. The third path is different from the first cleaning path. The second cleaning path is different from the first cleaning path and the third path. The second cleaning path is substantially parallel to the first cleaning path. The path switching position is a starting position at which the first cleaning path is switched to the second cleaning path. The path switching position is away from the bottom of the first wall and a waterline of the target water region.

### BRIEF DESCRIPTION OF THE DRAWINGS

FIG. 1 is a schematic flowchart of a first embodiment of a cleaning device control method according to this application;

FIG. 2 is a schematic flowchart of a second embodiment of a cleaning device control method according to this application;

FIG. 3 is a schematic flowchart of a third embodiment of a cleaning device control method according to this application;

FIG. 4 is a schematic diagram of a first embodiment of path planning according to this application;

FIG. 5 is a schematic diagram of a second embodiment of path planning according to this application;

FIG. 6 is a schematic diagram of a third embodiment of path planning according to this application;

FIG. 7 is a schematic diagram of a fourth embodiment of path planning according to this application;

FIG. 8 is a schematic flowchart of a fourth embodiment of a cleaning device control method according to this application;

FIG. 9a is a schematic diagram of a first embodiment of a first cleaning path and a second cleaning path according to this application;

FIG. 9b is a schematic diagram of a first embodiment of a first cleaning path according to this application;

FIG. 9c is a schematic diagram of a second embodiment of a first cleaning path according to this application;

FIG. 9d1 is a schematic diagram of a third embodiment of a first cleaning path according to this application;

FIG. 9d2 is a schematic diagram of a fourth embodiment of a first cleaning path according to this application;

FIG. 9e is a schematic diagram of a second embodiment of a first cleaning path and a second cleaning path according to this application;

FIG. 9f is a schematic diagram of a third embodiment of a first cleaning path and a second cleaning path according to this application;

FIG. 9g is a schematic diagram of a fourth embodiment of a first cleaning path and a second cleaning path according to this application;

FIG. 9h is a schematic diagram of a fifth embodiment of a first cleaning path and a second cleaning path according to this application;

FIG. 9i is a schematic diagram of a sixth embodiment of a first cleaning path and a second cleaning path according to this application;

FIG. 9j is a schematic diagram of a seventh embodiment of a first cleaning path and a second cleaning path according to this application;

FIG. 9k is a schematic diagram of an eighth embodiment of a first cleaning path and a second cleaning path according to this application;

FIG. 9l is a schematic diagram of a ninth embodiment of a first cleaning path and a second cleaning path according to this application;

FIG. 10 is a schematic flowchart of a fifth embodiment of a cleaning device control method according to this application;

FIG. 11 is a schematic diagram of a water surface cleaning trajectory of a target water region according to an embodiment of this application;

FIG. 12 is a schematic flowchart of a sixth embodiment of a cleaning device control method according to this application;

FIG. 13 is a schematic flowchart of a seventh embodiment of a cleaning device control method according to this application;

FIG. 14 is a schematic flowchart of an eighth embodiment of a cleaning device control method according to this application;

FIG. 15 is a schematic structural diagram of a cleaning device according to an embodiment of this application;

FIG. 16 is a schematic diagram of a frame structure of a computer-readable storage medium according to an embodiment of this application;

FIG. 17 is a schematic diagram of a frame structure of a cleaning device control apparatus according to an embodiment of this application;

FIG. 18 is a schematic diagram of a fifth embodiment of path planning according to this application;

FIG. 19 is a schematic diagram of an embodiment of a relatively longest path according to this application;

FIG. 20 is a schematic diagram of a sixth embodiment of path planning according to this application;

FIG. 21 is a schematic diagram of an embodiment of a motion path of a cleaning device according to this application;

FIG. 22 is a top view of an embodiment of a target water region according to this application; and

FIG. 23 is a schematic diagram of a fifth embodiment of a first cleaning path according to this application.

### DETAILED DESCRIPTION

The following clearly and completely describes the technical solutions in embodiments of this application with reference to the accompanying drawings in embodiments of this application. It is clear that the described embodiments are merely some but not all of embodiments of this application. All other embodiments obtained by a person of ordinary skill in the art based on embodiments of this application without creative efforts shall fall within the protection scope of this application.

It should be noted that the descriptions “first”, “second”, and the like in embodiments of this application are merely intended for a purpose of description, and shall not be understood as an indication or implication of relative importance or an implicit indication of a quantity of indicated technical features. Therefore, a feature limited by “first” or “second” may explicitly or implicitly include at least one of the features.

An “embodiment” mentioned in this specification indicates that a particular feature, structure, or characteristic described with reference to this embodiment may be included in at least one embodiment of this application. The phrase shown in various positions in this specification may not necessarily refer to a same embodiment, and is not an independent or optional embodiment exclusive from another embodiment. It is explicitly and implicitly understood by a person skilled in the art that embodiments described in this specification may be combined with another embodiment.

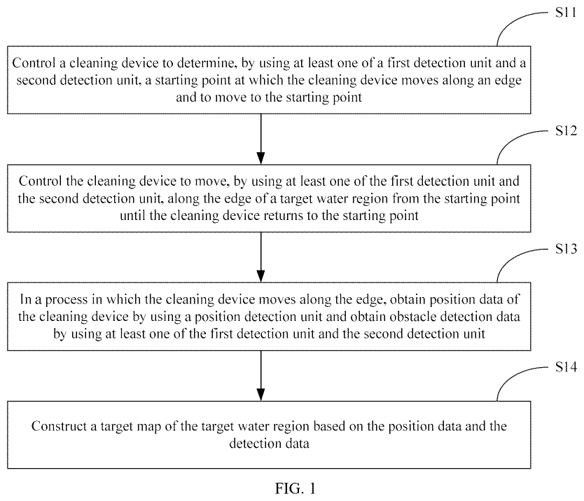

Refer to FIG. 1. FIG. 1 is a schematic flowchart of a first embodiment of a cleaning device control method according to this application. The method includes the following steps.

S11: Control a cleaning device to determine, by using at least one of a first detection unit and a second detection unit, a starting point at which the cleaning device moves along an edge and to move to the starting point.

In one embodiment, the cleaning device moves in water. The cleaning device includes a detection unit. The detection unit includes at least the first detection unit disposed on a front portion, the second detection unit disposed on a side portion, a position detection unit, and a control unit connected to the detection unit through a signal. The cleaning device may be a robot, for example, a pool robot or an underwater robot. The first detection unit and the second detection unit are disposed on the cleaning device. Each of the first detection unit and the second detection unit may include a distance measurement sensor. The distance measurement sensor includes, but is not limited to, a line laser sensor, a radar sensor, a lidar, an ultrasonic sensor, an infrared sensor, and the like. Each of the first detection unit and the second detection unit may further include an acoustic radar, a vision sensor, and the like. The side portion may be a left side portion or a right side portion of the cleaning device. The first detection unit and/or the second detection unit may alternatively be disposed at a position on the cleaning device other than the front portion and the side portion, such as the top, the bottom, a rear portion, an intersection of different portions, or the like.

When the cleaning device enters a target water region, the cleaning device is controlled to rotate around at a water entry position, a position on a wall closest to the cleaning device is determined as the starting point, and the cleaning device moves to the starting point in a preset direction. An included angle between the preset direction and the wall meets a preset angle. The preset angle may be set by a user. For example, the preset angle is 90°, 85°, or 95°. This is not limited herein. Specifically, the cleaning device obtains a target distance between the water entry position and each wall of the target water region by using at least one of the first detection unit and the second detection unit during rotation. The water entry position may be on a water surface, in the water, or on the bottom of the target water region. A smallest target distance is selected from various target distances. A wall corresponding to the smallest target distance is taken as a target wall, that is, the target wall is a wall of the target water region closest to the water entry position. The cleaning device is controlled to rotate to face the target wall and move toward the target wall in the preset direction. A position at which the cleaning device reaches the target wall is the starting point. An example in which the water entry position of the cleaning device is at the bottom of the target water region is used. The first detection unit in a moving direction of the cleaning device is used to detect a target distance between the front portion of the cleaning device and each wall of the target water region. The cleaning device is controlled to rotate until the front portion faces a target wall corresponding to a smallest target distance, and the cleaning device is controlled to move to the target wall. When the front portion of the cleaning device collides with the target wall, or when a distance between the front portion of the cleaning device and the target wall meets a specific distance, a position at which the cleaning device is located is taken as the starting point. It may be understood that in other embodiments, the starting point may alternatively be determined based on a distance between each of the left side portion and the right side portion of the cleaning device and the target wall or a distance between a center point of the cleaning device and the target wall. In one embodiment, the cleaning device may move from the water entry position in any direction until the cleaning device abuts against any wall or a distance between the cleaning device and any wall meets a preset requirement. A contact point or a stopping point is taken as the starting point. Then, a moving direction is adjusted to be a direction substantially parallel to the wall.

In other embodiments, the cleaning device determines whether the cleaning device needs to enter the bottom of the target water region. For example, if the cleaning device only needs to clean the water surface or construct a map of the water surface, the cleaning device does not need to enter the bottom of the target water region. If the cleaning device needs to enter the bottom of the target water region, water may be sucked into a buoyancy cavity inside the cleaning device by using a peristaltic pump inside the cleaning device, and air inside the buoyancy cavity is discharged (in a process of entering the water, an air outlet of the cleaning device is kept on the top of the cleaning device in a vertical direction as much as possible to discharge the air), so that the cleaning device is submerged. The buoyancy cavity belongs to a part of a mode switching member of the cleaning device, and the mode switching member can be configured to implement pose switching of the cleaning device among the bottom, the wall, and the water surface of the target water region.

S12: Control the cleaning device to move, by using at least one of the first detection unit and the second detection unit, along the edge of the target water region from the starting point until the cleaning device returns to the starting point.

In one embodiment, moving along the edge of the target water region is moving along a boundary of the target water region, and may be moving along an edge of the bottom of the target water region or moving along an edge of the water surface of the target water region.

The target water region includes, but is not limited to, a swimming pool, an ornamental reservoir, a wild pool, and the like. When the cleaning device is a pool robot, the pool robot may be located on the water surface of the target water region or the bottom of the target water region, or suspended in the target water region. In a case where the target water region is a swimming pool, the pool robot may alternatively be located on a wall of the swimming pool. A contour of the target water region may be of a shape of a square, a circle, an ellipse, or the like.

In a process in which the cleaning device moves along the edge, a distance between the cleaning device and a wall of the target water region may be controlled to be less than a preset distance to ensure that the cleaning device effectively moves along the edge. Specifically, a distance between the front portion of the cleaning device and an obstacle in front of the cleaning device is controlled to be less than a preset distance by using the first detection unit, and/or a distance between the side portion of the cleaning device and an obstacle on a side of the cleaning device is controlled to be less than a preset distance by using the second detection unit.

In one embodiment, whether the cleaning device returns to the starting point may be determined based on a variation of a pose of the cleaning device. Specifically, a current pose of the cleaning device at a current moment and an initial pose of the cleaning device at the starting point are obtained, and a variation of the current pose relative to the initial pose is calculated. If the variation of the current pose relative to the initial pose meets a preset threshold, it is determined that the cleaning device returns to the starting point, or if the variation of the current pose relative to the initial pose does not meet the preset threshold, the cleaning device is controlled to continue to move along the edge. The preset threshold may be set by the user. This is not specifically limited herein. The pose may include at least one of a position and a yaw angle/azimuth. The preset threshold includes at least one of a preset position variation and a preset yaw angle/azimuth variation.

In one specific embodiment, a current position of the cleaning device is obtained, and whether a distance between the current position and an initial position meets the preset position variation is determined. If the distance between the current position and the initial position meets the preset position variation, it is determined that the cleaning device returns to the starting point. In another embodiment, a current azimuth of the cleaning device is obtained, and whether a difference between the current azimuth and an initial azimuth meets the preset azimuth variation is determined. If the difference between the current azimuth and the initial azimuth meets the preset azimuth variation, it is determined that the cleaning device returns to the starting point. Alternatively, a current yaw angle of the cleaning device is obtained, and whether a difference between the current yaw angle and an initial yaw angle meets the preset yaw angle variation is determined. If the difference between the current yaw angle and the initial yaw angle meets the preset yaw angle variation, it is determined that the cleaning device returns to the starting point. The preset position variation, the preset azimuth variation, and the preset yaw angle variation may be set as required. This is not specifically limited herein. In another embodiment, in the process of moving along the edge, the cleaning device detects a distance between the cleaning device and the starting point and a yaw angle of the cleaning device at the starting point. When the distance between the cleaning device and the starting point is less than a specific distance, the cleaning device has a tendency to be first close to and then away from the starting point, and it is detected that a variation of the current yaw angle relative to the initial yaw angle is less than a preset angle, for example, 90°, it is determined that the cleaning device returns to the starting point; or in the process of moving along the edge, an accumulated angle by which the cleaning device moves from the starting point to a current position is greater than or equal to a preset angle, for example, 360°+90°, it is determined that the cleaning device returns to the starting point.

In one embodiment, in the process in which the cleaning device moves along the edge, if a sensor such as the first detection unit detects that there is an obstacle in the moving direction of the cleaning device, the cleaning device decelerates to prevent the cleaning device from colliding with the obstacle due to a high speed. After the cleaning device changes the moving direction to avoid the obstacle, the cleaning device continues to move along the edge.

S13: In the process in which the cleaning device moves along the edge, obtain position data of the cleaning device by using the position detection unit and obtain obstacle detection data by using at least one of the first detection unit and the second detection unit.

In one embodiment, the position detection unit may be a sensor capable of detecting a position of the cleaning device, and position data at each moment may also be referred to as pose data of the cleaning device. For example, the pose data includes x, y, and yaw, which respectively indicate a horizontal coordinate, a vertical coordinate, and an azimuth. The obstacle detection data includes at least one of a position of the obstacle, a distance between the obstacle and the cleaning device, and a type of the obstacle.

In one embodiment, the position detection unit is the first detection unit or the second detection unit. In other words, the first detection unit or the second detection unit may obtain both the obstacle detection data and the position data. For example, in a case where the first detection unit or the second detection unit is a visual sensor, the first detection unit or the second detection unit may take a picture of the target water region, and the cleaning device may obtain a feature point of the target water region from the taken picture. As the cleaning device moves, new pictures are continuously taken, and new feature points are continuously obtained. A position of a feature point at a previous moment is compared with a position of the feature point at a current moment, so that a change in the moving direction of the cleaning device from the previous moment to the current moment and a moving distance can be deduced. On this basis, position data of the cleaning device at the current moment can be obtained based on position data of the cleaning device at the previous moment.

S14: Construct a target map of the target water region based on the position data and the detection data.

The target map of the target water region may include one or more of a target map of the water surface, a target map of the bottom of the target water region, a target map of the wall of the target water region, and a target map of the entire target water region.

In one embodiment, an example of constructing the target map of the water surface of the target water region is used. The position data includes position data of each of N moments obtained in a case where the cleaning device moves along the edge of the water surface of the target water region and does not complete a predetermined path for moving along the edge. The detection data includes a group of ultrasonic data. The group of ultrasonic data includes data of a reflected signal received by the cleaning device after the cleaning device sends an ultrasonic signal in a predetermined direction at each of the N moments. N is a positive integer greater than or equal to 2. That the cleaning device does not complete a predetermined path for moving along the edge indicates that the cleaning device has not returned to the starting point. The detection unit on the cleaning device may be an ultrasonic sensor. Whether there is an obstacle near the cleaning device is detected by using the ultrasonic sensor. The obstacle includes a wall or the like. The above N moments may be moments for obtaining data for a plurality of times based on a preset period. For example, data may be obtained once every 20 ms (or another period). The data obtained each time includes the position data and the ultrasonic data. Certainly, the data may not be obtained based on a fixed period.

Coordinate information of the obstacle detected by the cleaning device at each of the N moments can be obtained based on the position data of each of the N moments and the ultrasonic data corresponding to each of the N moments. The target map of the water surface of the target water region may be constructed based on the coordinate information of the obstacle. For example, a grid, corresponding to coordinates of the obstacle, in a grid map is marked as an obstacle, so that after the cleaning device completes the predetermined path for moving along the edge during moving on the water surface of the target water region, a plurality of obstacles may be marked in the grid map. For example, after the cleaning device moves on the water surface of the target water region by one circle or one round, the target map of the water surface of the target water region may be obtained. In actual application, after the target map of the water surface is constructed, the cleaning device may perform a corresponding operation on the pool based on the constructed target map, such as performing a cleaning operation, disinfection, water quality testing, or other operations.

In one embodiment, position data of each of the N moments is represented as current position data, and the current position data is used to represent position data of the cleaning device at a current moment in the N moments. In one specific embodiment, a target propeller and an inertial measurement unit (IMU) are further disposed on the cleaning device. Motion data of the target propeller at the current moment and angle data of the cleaning device obtained by the IMU at the current moment are obtained, and then the current position data is obtained based on the motion data and the angle data. The motion data may be a rotation speed or a linear velocity of the target propeller. In this case, a moving distance at the current moment relative to a previous moment may be obtained based on the rotation speed or the linear velocity of the target propeller, and then the current position data of the cleaning device at the current moment may be obtained based on the moving distance and the angle data. The target propeller may include a motor and an impeller, and may be disposed at the rear of the cleaning device. In actual application, the target propeller may be a single propeller or a plurality of propellers. For example, one propeller may be disposed on each of a left side and a right side of the rear of the cleaning device. The cleaning device moves on the water surface under a driving force generated by the propeller of the cleaning device. According to this embodiment, the current position data of the cleaning device on the water surface is determined based on the motion data of the target propeller and the angle data of the IMU. In another specific embodiment, a center point linear velocity of the cleaning device may be determined based on the rotation speed of the target propeller. The center point linear velocity is used to indicate a moving distance of a center point of the cleaning device per unit time. The moving distance of the cleaning device at the current moment relative to the previous moment is determined based on the center point linear velocity.

In the above embodiment, position data of obstacles on the water surface may be determined based on a group of position data and a group of ultrasonic data. For example, data of N coordinate pairs may be obtained based on position data of each of the N moments and ultrasonic data corresponding to each of the N moments, and then coordinate information of the obstacles detected at different moments may be obtained, that is, the position data of the obstacles detected at different moments in the process in which the cleaning device moves along the edge of the water surface may be obtained. Then, the target map of the water surface may be obtained by performing marking on the grid map based on the position data of the obstacles, or the target map of the water surface may be obtained by recording the position data of the obstacles.

In the above embodiment, when the cleaning device is a pool robot, the pool robot is equipped with a buoyancy cavity and a water pump for sucking and discharging water, and has a water surface cleaning function. In addition, the pool robot is equipped with a scheme for performing positioning and estimation on the water surface to implement functions of performing positioning on the water surface and constructing a map of the water surface. The pool robot moves forward and backward on the water surface mainly through forward rotation and reverse rotation of the propeller, and a left propeller and a right propeller have different rotation speeds, so that the pool robot can turn left or right.

After the map of the water surface is constructed, path planning may be performed based on a map construction result, and then water surface cleaning may be completed. Processes of constructing maps of the bottom and the wall of the target water region may be implemented in steps similar to those described above. Details are not described herein again. According to the above embodiment, the scheme for performing positioning on the water surface based on the rotation speed of the propeller is proposed to estimate the position of the robot and construct a map, for example, a grid map, in a case where it is extremely difficult to perform positioning on the water surface and control motion. In this way, a device motion strategy can be executed more accurately based on a positioning result and the map, and after the robot finishes moving along the edge of the water surface, paths covering the water surface can be calculated based on the constructed map, for example, the grid map, and a reasonable cleaning strategy can be executed.

In the above manner, in the process in which the cleaning device moves along the edge, the position data of the cleaning device is obtained by using the position detection unit, the obstacle detection data is obtained by using at least one of the first detection unit and the second detection unit, and the target map of the target water region is constructed based on the position data and the detection data.

In one embodiment, a mode switching member is further disposed on the cleaning device. When the cleaning device needs to move from the bottom of the target water region to the water surface of the target water region or from the water surface of the target water region to the bottom of the target water region, motion modes of the cleaning device may be switched by using the mode switching member. The mode switching member is connected to the control unit, and the control unit controls state switching of the cleaning device by adjusting a volume of gas or liquid in the mode switching member. For example, a process in which the cleaning device moves from the bottom of the target water region to the water surface includes a process of controlling the cleaning device to move from the wall of the target water region to a waterline, and the control unit controls, by increasing the volume of gas and/or decreasing the volume of liquid in the mode switching member, the cleaning device to be switched to a water surface motion state.

In another embodiment, in the process in which the cleaning device moves along the edge, if the first detection unit detects that there is an obstacle ahead, the cleaning device may be controlled to decelerate when a distance between the cleaning device and the obstacle is a first preset distance, for example, 70 cm, to prevent the cleaning device from strongly colliding with the obstacle, and when the cleaning device is close to the obstacle, and the distance therebetween reaches a second preset distance, the cleaning device is controlled to avoid the obstacle and continue to move along the edge, that is, the cleaning device is controlled to go around a contour of the obstacle and move along the edge.

In one embodiment, the target map of the water surface and the target map of the bottom of the target water region are constructed based on obstacle detection data from different obstacle detection units (namely, the first detection unit and the second detection unit), or based on position data from different position detection units. For example, the position detection units include a third detection unit and a fourth detection unit. The third detection unit and the fourth detection unit are disposed at different positions on the cleaning device. In a height direction of the cleaning device, the third detection unit is higher than the fourth detection unit. When the target map of the water surface is constructed, the obtained position data is from the third detection unit. When the target map of the bottom of the target water region is constructed, the obtained position data is from the fourth detection unit.

When moving on the water surface, the cleaning device is generally partially exposed at the water surface and partially submerged in the water. When moving on the bottom of the target water region, the cleaning device is generally completely submerged in the water. There is a difference between a position of the cleaning device relative to the bottom of the target water region and a position of the cleaning device relative to the water surface. A same obstacle detection unit or position detection unit is used, leading to omission or deviation of the obtained obstacle detection data or the obtained position data. For example, when the cleaning device is located on the water surface, the obstacle detection unit disposed at a lower portion of the cleaning device may be located underwater, and cannot accurately detect an obstacle on the water surface. Therefore, different detection units are disposed to obtain the obstacle detection data or the position data, so that an obstacle detection unit or a position detection unit at an appropriate position can be selected based on a condition of the water surface and a condition of the bottom of the target water region. In this way, the obstacle detection data or the position data can be accurately obtained.

In one specific embodiment, there may be a difference in structures of different obstacle detection units or different position detection units. The third detection unit and the fourth detection unit are used as an example. When the third detection unit is configured to obtain position data on the water surface, the third detection unit may be a visual sensor, such as a camera. When the fourth detection unit is configured to obtain position data at the bottom of the target water region, the fourth detection unit may be a laser sensor, such as a lidar sensor or a laser module plus a camera. At the bottom of the target water region, the fourth detection unit may emit a laser to the water to increase feature points, to resolve a problem of few feature points at the bottom. In comparison, because an environment of the water surface is complex, and there are many feature points, there is no need to increase feature points, and the third detection unit can directly identify the existing feature points. Therefore, detection units with different structures are disposed to obtain the obstacle detection data or the position data, so that an obstacle detection unit or a position detection unit with an appropriate structure can be selected based on a condition of the water surface and a condition of the bottom of the target water region. In this way, the obstacle detection data or the position data can be accurately obtained.

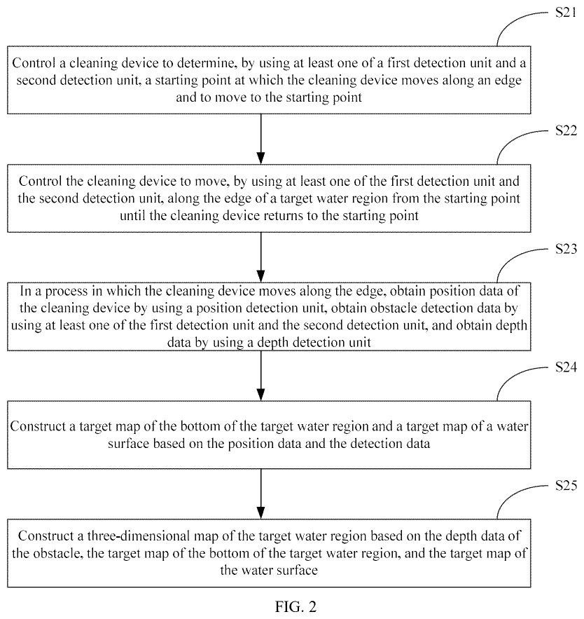

Refer to FIG. 2. FIG. 2 is a schematic flowchart of a second embodiment of a cleaning device control method according to this application. The method includes the following steps.

S21: Control a cleaning device to determine, by using at least one of a first detection unit and a second detection unit, a starting point at which the cleaning device moves along an edge and to move to the starting point.

S22: Control the cleaning device to move, by using at least one of the first detection unit and the second detection unit, along the edge of a target water region from the starting point until the cleaning device returns to the starting point.

S23: In a process in which the cleaning device moves along the edge, obtain position data of the cleaning device by using a position detection unit, obtain obstacle detection data by using at least one of the first detection unit and the second detection unit, and obtain depth data by using a depth detection unit.

The depth data includes at least one of depth data of an obstacle, depth data of the target water region, and depth data of the cleaning device. The depth data of the obstacle is depth data of a position at which the obstacle is located in the target water. The depth data of the cleaning device is depth data of a position at which the cleaning device is located in the target water. The depth data of the target water region is water depth data of the target water region.

S24: Construct a target map of the bottom of the target water region and a target map of a water surface based on the position data and the detection data.

For specific implementation of steps S21 to S24, refer to related descriptions of the first embodiment of the cleaning device control method provided in this application. Details are not described herein again.

In another embodiment, in the process in which the cleaning device moves along the edge, a target obstacle in the target water region is detected by using at least one of the first detection unit and the second detection unit. The target obstacle may be any obstacle. In a case where it is determined that the target obstacle is detected, a relative position relationship between the target obstacle and the cleaning device is obtained, and a first position of the cleaning device at a target moment at which the target obstacle is detected is obtained by using the position detection unit. A second position of the target obstacle is determined based on the relative position relationship and the first position of the cleaning device at the target moment, and a target map of the target water region is constructed based on the second position of the target obstacle. The target map of the target water region includes the target map of the bottom of the target water region and the target map of the water surface. In one embodiment, when coordinates of each of the first position and the second position include only a horizontal coordinate and a vertical coordinate in a global coordinate system, the constructed target map is a two-dimensional map. In another embodiment, when coordinates of each of the first position and the second position include a horizontal coordinate, a vertical coordinate, and a depth coordinate in the global coordinate system, the constructed target map is a three-dimensional map.

S25: Construct a three-dimensional map of the target water region based on the depth data, the target map of the bottom of the target water region, and the target map of the water surface.

In one embodiment, when each of the target map of the bottom of the target water region and the target map of the water surface is a two-dimensional map, a horizontal coordinate and a vertical coordinate of each position point in the map in the global coordinate system may be obtained from the map, and then the three-dimensional map of the target water region is constructed based on depth data of each position point detected by a depth sensor. When each of the target map of the bottom of the target water region and the target map of the water surface is a three-dimensional map, three-dimensional coordinates of each position point in the map may be obtained directly, and the above determined three-dimensional coordinates may be corrected by using a plurality of sensors (for example, a depth sensor and a distance sensor) mounted in the target water region or on the cleaning device.

In one specific embodiment, the constructing a three-dimensional map of the target water region includes: obtaining a displacement of the cleaning device per unit time by using a code disk disposed inside the cleaning device; determining sub-displacements of the displacement in a plurality of directions per unit time based on Euler angles of the cleaning device before the cleaning device is displaced, where the Euler angles are determined by using an inertial measurement unit disposed inside the cleaning device; accumulating sub-displacements in the plurality of directions in N units of time to an initial position of the cleaning device, and determining the first position of the cleaning device at the target moment based on an accumulation result, where N is a natural number greater than or equal to 1, N is determined based on a difference between the target moment and an initial moment, the initial position is a position at the initial moment, and the first position and the initial position are positions of the cleaning device in the global coordinate system; determining the second position of the target obstacle based on the relative position relationship between the target obstacle and the cleaning device and the first position of the cleaning device at the target moment; and constructing the three-dimensional map of the target water region based on the second position of the target obstacle, where coordinates of the first position, the second position, and the initial position are three-dimensional coordinates. The Euler angles may be attitude angles described below.

In one embodiment, the determining the first position of the cleaning device at the target moment based on an accumulation result includes: determining a depth of the cleaning device by using the depth sensor disposed inside the cleaning device, and calibrating, based on the depth of the cleaning device, an accumulated target depth included in the accumulation result, to obtain the first position of the cleaning device at the target moment. In the above embodiment, calibrating the first position includes calibrating the depth coordinate of the first position. A calibration manner may include determining a value of the depth of the cleaning device as the depth coordinate of the first position in a case where a difference between the depth of the cleaning device and the accumulated target depth exceeds a preset threshold, or determining an average value of the depth of the cleaning device and the accumulated target depth as the depth coordinate of the first position in a case where the difference between the depth of the cleaning device and the accumulated target depth exceeds the preset threshold. In a case where the difference between the depth of the cleaning device and the accumulated target depth is less than the preset threshold, the calibration manner may include, but is not limited to, determining a value of the accumulated target depth as the depth coordinate of the first position and determining the value of the depth of the cleaning device as the depth coordinate of the first position. The preset threshold may be two, three, or five depth units. When the cleaning device constructs a map of the water surface, the accumulated target depth may be 0. The accumulation result is determined based on the first position at the beginning of a previous unit time and a displacement of the cleaning device during the previous unit time. Coordinates of the first position may be current coordinates obtained by performing accumulation based on coordinates of the cleaning device that have been calibrated at the previous unit time. Optionally, the determining the first position of the cleaning device at the target moment based on an accumulation result further includes: when the cleaning device moves on the water surface of the target water region, correcting the accumulated target depth based on a depth of the cleaning device in the target water region obtained by using the depth sensor disposed inside the cleaning device. The first position is calibrated based on the depth of the cleaning device determined by using the depth sensor, so that a positioning error can be systematically reduced, and positioning accuracy can be improved.

In one embodiment, the relative position relationship includes a target position of the target obstacle in a coordinate system of the cleaning device. The target position is determined based on a distance and an angle between the target obstacle and the cleaning device. The distance and the angle between the target obstacle and the cleaning device may be determined based on data detected by a target sensor disposed inside the cleaning device.

In one embodiment, a translation transformation relationship between the target position and the second position of the target obstacle is determined based on a displacement of the cleaning device at the first position at the target moment relative to an origin of the global coordinate system. The relative position relationship includes the target position of the target obstacle in the coordinate system of the cleaning device. The target position is a position of the target obstacle in the coordinate system of the cleaning device. The second position is a position of the target obstacle in the global coordinate system. A rotation transformation relationship between the target position and the second position of the target obstacle is determined based on Euler angles of the cleaning device at the target moment. The Euler angles are determined by using the inertial measurement unit disposed inside the cleaning device. The target position is converted into the second position of the target obstacle based on the rotation transformation relationship and the translation transformation relationship. In the above embodiment, the translation transformation relationship may be represented by a translation matrix, and the rotation transformation relationship may be represented by a rotation matrix. The second position may be obtained by performing an operation on the translation matrix, the rotation matrix, and the target position. In the above embodiment, a transformation relationship between the global coordinate system and the coordinate system of the cleaning device is determined based on pose information of the cleaning device in the global coordinate system, and then coordinates of the target obstacle in the coordinate system of the cleaning device are converted into coordinates in the global coordinate system, to effectively determine a three-dimensional voxel, corresponding to the target obstacle, in the map.

A voxel corresponding to the second position of the target obstacle is marked in an initial three-dimensional map, and in a case where it is determined that the cleaning device has moved along a boundary of the target water region by one round, map construction is completed, and the three-dimensional map of the target water region is obtained. In the above embodiment, a marking manner includes determining a position of a three-dimensional voxel, corresponding to the target obstacle, in the initial three-dimensional map based on ratios of coordinate values corresponding to the second position of the target obstacle to a preset resolution, to mark the three-dimensional voxel. If a voxel is marked as the target obstacle, the voxel is displayed in the initial three-dimensional map. If a voxel is not marked as the target obstacle, the voxel is not displayed. The initial three-dimensional map is a global map composed of a voxel.

Before the relative position relationship between the target obstacle and the cleaning device is obtained, the above implementation further includes: obtaining distances between the cleaning device and a plurality of boundaries of the target water region in a case where the cleaning device enters the target water region; determining a target boundary based on the distances, where the target boundary is a boundary closest to the cleaning device and included in the plurality of boundaries; and controlling the cleaning device to move to the target boundary and move along the boundaries of the target water region from the target boundary. In the above embodiment, the method for determining the distances between the cleaning device and the boundaries includes, but is not limited to, directly measuring the distances by using a distance sensor, measuring the distances by using an image shooting device disposed on the cleaning device, measuring the distances by using a pose sensor, and the like. The distances between the cleaning device and the plurality of boundaries are determined, to determine the target boundary and control the cleaning device to move to the target boundary. This can shorten map construction preparation time of the cleaning device and effectively improve overall map construction efficiency.

In one specific embodiment, the cleaning device is a pool robot. An ultrasonic sensor and a depth sensor are disposed on the pool robot. After the pool robot starts a map construction task, the pool robot is controlled to enter the target water region and start to move along the boundary of the target water region, and the pool robot determines whether the pool robot has moved along the boundary of the target water region by one round. In a case where the pool robot has moved along the boundary of the target water region by one round, the map construction task ends, and the three-dimensional map of the target water region is generated. Otherwise, the pool robot obtains a variation of an angle of the pool robot by using the inertial measurement unit during moving, obtains a variation of a displacement of the pool robot based on data obtained by using the code disk, and then calculates current three-dimensional coordinates of the pool robot based on initial three-dimensional coordinates of the pool robot. The pool robot obtains, by using the depth sensor, a depth of a position in which the pool robot is located in the target water region, and corrects, based on the depth of the cleaning device, the depth coordinate determined based on the accumulated target depth in the current three-dimensional coordinates. The pool robot obtains target coordinates of the obstacle by using the ultrasonic sensor. The target coordinates of the obstacle are coordinates of the obstacle in a coordinate system of the pool robot. The pool robot determines a transformation relationship between the target coordinates of the target obstacle and three-dimensional coordinates of the target obstacle based on current Euler angles and the current three-dimensional coordinates of the pool robot, and obtains the three-dimensional coordinates of the target obstacle based on the transformation relationship. The three-dimensional coordinates of the target obstacle are coordinates of the target obstacle in the global coordinate system. The pool robot marks a three-dimensional voxel, corresponding to the three-dimensional coordinates of the target obstacle, in the initial three-dimensional map, and continues to move along the boundary of the target water region until map construction is completed.

In one embodiment, after the target map is obtained in any one of the foregoing manners, the method may include at least one of the following steps: constructing a target map model based on the target map, where the target map model includes a bottom model, a wall model, and a water surface model of the target water region; constructing a three-dimensional rendered map of the target water region based on the bottom model, the wall model, and the water surface model of the target water region and displaying the three-dimensional rendered map on a terminal, where the three-dimensional rendered map supports independent splitting for independent selection of a user; and controlling the cleaning device to perform a target operation on a selected split unit.

The constructing a target map model based on the target map includes: mapping a plurality of pieces of two-dimensional coordinate information to the initial three-dimensional map to obtain target three-dimensional coordinate information, where the two-dimensional coordinate information is grid information, of a target position point in the target water region, pre-detected by the cleaning device, and may be obtained based on the target map, and the target position point may be a position point in the target water region detected by the cleaning device when the cleaning device constructs the target map, and include a position point on the bottom of the target water region, a position point on the wall, and a position point on an object in the target water region (for example, an obstacle or a landscape in the target water region); generating the bottom model of the target water region in the three-dimensional map of the target water region based on bottom information of the target water region included in the target three-dimensional coordinate information; and generating the wall model and the water surface model of the target water region in the three-dimensional map of the target water region based on the bottom information.

An example in which the target water region is a pool is used. The initial three-dimensional map includes the target three-dimensional coordinate information obtained by performing mapping based on grip data obtained when the cleaning device currently moves in the pool, and the three-dimensional map of the pool may be obtained by performing various rendering operations based on the target three-dimensional coordinate information. The initial three-dimensional map may include other rendered models (for example, a model of a house and a model of a tree) other than the three-dimensional map of the pool. An operation trajectory of the cleaning device in the three-dimensional map of the pool corresponds to a trajectory line generated in real time when the cleaning device moves in the pool. In addition, the initial three-dimensional map may alternatively be pre-constructed. In addition, after the cleaning device is repositioned to determine coordinates of the cleaning device, the trajectory line generated in real time when the cleaning device moves may be added to the three-dimensional map of the pool. An occasion for constructing the initial three-dimensional map is not limited in this application.

In one embodiment, the mapping a plurality of pieces of two-dimensional coordinate information to the initial three-dimensional map includes: traversing the plurality of pieces of two-dimensional coordinate information to determine information of a second position point with a largest coordinate value and information of a third position point with a smallest coordinate value that are included in the plurality of pieces of two-dimensional coordinate information; determining a coordinate origin of the initial three-dimensional map based on information of a fourth position point located at a middle position between the second position point and the third position point; and mapping the plurality of pieces of two-dimensional coordinate information to the initial three-dimensional map based on a difference between each piece of two-dimensional coordinate information and the coordinate origin. When the second position point and the third position point are determined, one of a plurality of world coordinate systems in which the robot is located when the robot detects a target position point may be used as a reference coordinate system, to obtain mapped coordinates of each position point mapped to the reference coordinate system. Then, the two position points with a largest coordinate value and a smallest coordinate value may be obtained therefrom. In addition, because height (or depth) information of the second position point and height (or depth) information of the third position point are both known in advance, height (or depth) information of the fourth position point can be calculated naturally. In this way, position information of the coordinate origin determined based on the information of the fourth position point can be known. Then, a position of each position point in the initial three-dimensional map can be determined based on coordinate differences between other position points and the coordinate origin. In this embodiment, the fourth position point may be directly determined as the coordinate origin, or the coordinate origin may be obtained by performing specific deviation processing based on the fourth position point. In addition, a view angle of the three-dimensional map of the target water region can be changed by mapping the two-dimensional coordinate information. For example, a center point of the three-dimensional map of the target water region under a three-dimensional view angle is used as a center point of the pool, to improve a generation effect of the map of the target water region.

In one embodiment, the generating the bottom model of the target water region in the three-dimensional map of the target water region based on bottom information of the target water region included in the target three-dimensional coordinate information includes: connecting coordinate points corresponding to position information of adjacent edges included in the bottom information; generating an edge connection graph of the bottom of the target water region in the three-dimensional map of the target water region based on a connection result; and rendering the edge connection graph of the bottom to obtain the bottom model. The bottom information may include position information of an edge located near a contour of the bottom of the target water region, position information of a central region of the bottom of the target water region, and position information of a region located near the central region of the bottom of the target water region. When the edge connection graph of the bottom is constructed, coordinate points corresponding to position information of edges of the target water region may be connected to obtain the edge connection graph of the bottom. If transition between some of lines in the edge connection graph of the bottom is abrupt, a joint between abrupt line segments may be smoothed to obtain the edge, of the bottom of the target water region, represented by smooth lines. In addition, the edge of the bottom of the target water region may be straight or curved, and a type of the edge may be determined based on a shape of a line segment formed after edge points are connected. For example, when connection lines of the edge points cannot form a straight line segment, a connection line segment before the connection lines that cannot form a straight line segment is considered as a line segment of a straight edge. When a series of edge points cannot be connected to form a straight line, the series of edge points is marked as irregular curve points, and connection lines of the irregular curve points are considered as line segments of a curved edge.

In one embodiment, the generating the water surface model of the target water region in the three-dimensional map of the target water region based on the bottom information includes: obtaining a distance, between each first position point on the water surface and the bottom of the target water region, pre-detected by the cleaning device; generating a connection graph of the water surface of the target water region in the three-dimensional map of the target water region based on the distance between each first position point and the bottom of the target water region; and rendering the connection graph of the water surface to obtain the water surface model.

In the above embodiment, position information, of each target position point, pre-detected by the cleaning device includes coordinate information of each target position point. Generally, coordinate information of a position point detected by the cleaning device includes coordinate point information in a two-dimensional coordinate system, namely, coordinate values in a world coordinate system in which the cleaning device is currently located. In addition, the cleaning device may determine depth information of each position point or a distance between each position point and a reference surface (for example, the bottom of the target water region) by using a depth detection sensor (for example, a radar sensor, an infrared sensor, and a pressure sensor) disposed inside the cleaning device or based on a specific algorithm. Therefore, a pre-detected depth (or a height relative to the reference surface) of the target position point is actually recorded in the cleaning device. In this way, the information of each position point can be completely mapped to three axes of the initial three-dimensional map.

In the above embodiment, the distance between each first position point and the bottom of the target water region may be determined based on a depth (or a height relative to the reference surface), of each first position point on the water surface, pre-detected by the cleaning device, so that some points on the water surface can be identified in the initial three-dimensional map. Then, a position of a part of the connection graph of the water surface in the three-dimensional map of the target water region can be obtained by connecting the identified points, and the entire connection graph of the water surface can be obtained by extending the part of the connection graph of the water surface outward to the wall of the target water region. In this way, the entire connection graph of the water surface can be rendered subsequently. In addition, in this embodiment, the entire connection graph of the water surface can also be rendered by using a Three.js technology, and all of regions between the water surface and the bottom of the target water region can also be rendered as textures of the water region.

In one embodiment, the generating the wall model of the target water region in the three-dimensional map of the target water region based on the bottom information includes: generating an inner wall model of the target water region in the three-dimensional map of the target water region based on the bottom information; and extending the inner wall model outward in the three-dimensional map of the target water region to generate the wall model of the target water region in the three-dimensional map of the target water region. In this embodiment, the wall of the actual target water region has a certain thickness. To make a shape of the target water region in the three-dimensional map closer to a shape of the actual target water region, after the inner wall model is generated, the inner wall model needs to be extended outward by a certain pixel (a size of the extending pixel may be determined based on the actual thickness of the wall, or a fixed pixel value is set, or the pixel value is set based on other conditions), to obtain a more real shape of the target water region.

In one embodiment, the generating an inner wall model of the target water region in the three-dimensional map of the target water region based on the bottom information includes: determining an edge line of the target water region in the three-dimensional map of the target water region based on the bottom information; extending the edge line upward by a predetermined height to generate a connection graph of the wall of the target water region in the three-dimensional map of the target water region; and rendering the connection graph of the wall to obtain the inner wall model. In this embodiment, the wall model is actually attached to an edge of the bottom model. Therefore, the edge of the bottom model may be extended upward (that is, in a direction of a Z-axis of the three-dimensional coordinate system) to generate the connection graph of the wall. During extension, a specific extension height may be set based on an actual situation. For example, a height of the wall model may be set to be equal to a height of the water surface model, or the wall model may be set to be higher than the water surface model. In addition, the cleaning device may pre-detect a height difference between the wall of the target water region and the water surface, and then the height of the wall model is set based on the pre-detected height difference. The height of the wall model may be set in a pre-configured manner.

In one embodiment, the extending the inner wall model outward in the three-dimensional map of the target water region to generate the wall model in the three-dimensional map of the target water region includes: extending the inner wall model outward by a predetermined quantity of pixel points in the three-dimensional map of the target water region to obtain an outer wall model; connecting a point on the inner wall model to a point on the outer wall model to form a wall gap-filling geometry; and rendering the wall gap-filling geometry to obtain the wall model. In this embodiment, each wall of the target water region actually has a certain thickness. To make the target water region presented in the three-dimensional map of the target water region closer to the actual target water region, the generated inner wall model may be extended outward, for example, by 2 pixel points, 5 pixel points, or another quantity of pixel points, or may be extended outward by a certain proportion (for example, 1/50 or 1/100) based on an overall width of the target water region. The outward extension actually indicates performing extension along an X-axis and/or a Y-axis in a direction away from the target water region. In addition, after each inner wall model is extended outward, there are gaps between the wall models. In this case, these gaps need to be filled. For example, in a case where the inner wall models are formed by connecting a plurality of line segments, adjacent line segments of the inner wall models are extended outward to form two outward extended line segments, each of two outward extended line segments has an endpoint close to an intersection point of the adjacent line segments, and the intersection point and two endpoints are connected to each other to form a triangle. Then, the triangle is extended from the bottom of the target water region to the top of the target water region to obtain the wall gap-filling geometry. Optionally, after connection, smooth transition processing may be further performed on the geometry formed through connection, so that the walls can be smoothly connected. In this embodiment, the wall models may be split and rendered through data splitting (that is, data belonging to different walls and the bottom of the target water region is distinguished by using specific code or a specific program, to determine position points corresponding to a wall or the bottom of the target water region). After splitting and rendering are performed, different regions may be rendered with different colors. After the wall models are split, in a subsequent work process, a specific wall model or a region on the bottom model of the target water region may be individually selected, and the cleaning device may be controlled to clean the region.

In one embodiment, after the wall model is generated, the method further includes: connecting points on an outer side of the wall model to form an outer contour of the wall of the target water region in the three-dimensional map of the target water region; forming a ground geometry located at a periphery of the target water region after the outer contour of the wall is hollowed out in the three-dimensional map of the target water region; and rendering the ground geometry to obtain a ground model located at the periphery of the target water region.

In one embodiment, the method further includes: obtaining position information of the cleaning device when the cleaning device operates in the target water region; mapping the position information of the cleaning device to the three-dimensional map of the target water region to obtain path data of the cleaning device in the three-dimensional map of the target water region; processing the path data to generate a trajectory geometry whose thickness is less than a target quantity of pixel points; and rendering the trajectory geometry to obtain an operation trajectory of the cleaning device in the three-dimensional map of the target water region. A width of the trajectory geometry may be determined based on a width of the cleaning device. In the above embodiment, a two-dimensional or three-dimensional cleaning device and the operation trajectory of the cleaning device may further be rendered in the three-dimensional map of the target water region. The operation trajectory of the cleaning device is determined based on an actual motion path of the cleaning device. Generally, a cleaning width of the cleaning device is determined based on the width of the cleaning device. Therefore, when the trajectory geometry of the cleaning device is generated, pre-stored width data of the cleaning device may be obtained, and then the trajectory geometry of the cleaning device is rendered based on the width data. In addition, considering that a height of the cleaning device is less than that of the target water region, the thickness of the trajectory geometry of the cleaning device may be set to be small, for example, one pixel point or two pixel points. The operation trajectory of the cleaning device is rendered, so that a user can view an operation progress of the cleaning device in real time. In this way, a cleaning progress and coverage area of the cleaning device can be intuitively known. This facilitates subsequent actions such as water use assessment, water drainage and exchange assessment, and other types of cleaning of the cleaning device.

In embodiments of this application, the walls and the bottom of the target water region can be observed and displayed from multiple dimensions. The user can freely select a specific region to observe and trigger the cleaning device to clean the region directionally. In this way, the cleaning device has a stronger fixed-point cleaning capability.

In one embodiment, after the wall model and the water surface model of the target water region in the three-dimensional map of the target water region are generated based on the bottom information, the three-dimensional map of the target water region may be displayed on an application interface of a target terminal connected to the cleaning device. The three-dimensional map of the target water region includes at least one of the bottom model, the wall model, and the water surface model of the target water region.

In one embodiment, after the three-dimensional map of the target water region is displayed on the application interface of the target terminal, the user may select the three-dimensional map of the target water region on the application interface. When the target terminal receives a selection instruction for the three-dimensional map of the target water region, a target region in the target water region is determined based on the selection instruction, and the cleaning device is controlled to move to the target region to perform a preset operation on the target region. The preset operation may include cleaning, disinfection, and the like. In this embodiment, the map of the target water region may be viewed by using a specific APP, and a region of the target water region (for example, a wall, the bottom of the target water region, or the water surface) may be selected by using the APP, to trigger a control instruction to control the cleaning device to move to the selected region to operate. The cleaning device may be controlled to move to a specific position point at the selected region (for example, a center point of the region, a starting point of an edge of the region, or a middle point of an edge of the region), or to move to a point at the selected region, where the point is closest to the cleaning device.

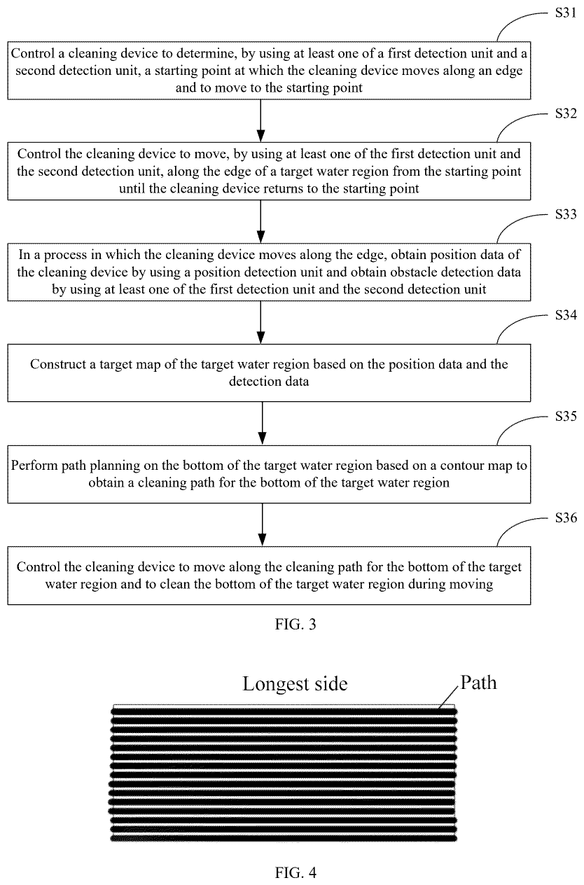

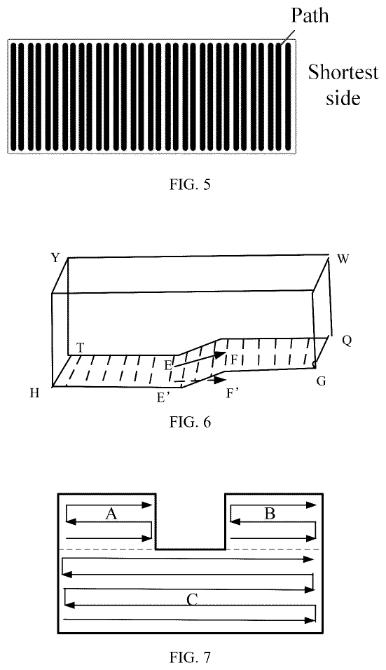

Refer to FIG. 3 to FIG. 7. FIG. 3 is a schematic flowchart of a third embodiment of a cleaning device control method according to this application. FIG. 4 is a schematic diagram of a first embodiment of path planning according to this application. FIG. 5 is a schematic diagram of a second embodiment of path planning according to this application. FIG. 6 is a schematic diagram of a third embodiment of path planning according to this application. FIG. 7 is a schematic diagram of a fourth embodiment of path planning according to this application. The method includes the following steps.

S31: Control a cleaning device to determine, by using at least one of a first detection unit and a second detection unit, a starting point at which the cleaning device moves along an edge and to move to the starting point.

S32: Control the cleaning device to move, by using at least one of the first detection unit and the second detection unit, along the edge of a target water region from the starting point until the cleaning device returns to the starting point.

S33: In a process in which the cleaning device moves along the edge, obtain position data of the cleaning device by using a position detection unit and obtain obstacle detection data by using at least one of the first detection unit and the second detection unit.

S34: Construct a target map of the target water region based on the position data and the detection data.

In one embodiment, the target map includes a contour map of the bottom of the target water region. For specific implementation of steps S31 to S34, refer to related descriptions of the first embodiment of the cleaning device control method provided in this application. Details are not described herein again.

In another embodiment, when the cleaning device sinks to the bottom of the target water region, the cleaning device is controlled to rotate around the target water region to find a boundary of the target water region. Specifically, a sensor (for example, an ultrasonic sensor) is disposed on the cleaning device, and the boundary of the target water region may be detected based on sensing information collected by the ultrasonic sensor. After the boundary of the target water region is detected, the cleaning device is controlled to move along the boundary of the bottom of the target water region. In a moving process of the cleaning device, the sensing information is collected by the sensor disposed on the cleaning device (for example, ultrasonic sensing information is collected by the ultrasonic sensor disposed on the cleaning device). The contour map of the bottom of the target water region is constructed based on boundary information of the bottom of the target water region included in the sensing information. The target water region includes a pool, a swimming pool, and the like, and the cleaning device includes a robot.

S35: Perform path planning on the bottom of the target water region based on the contour map to obtain a cleaning path for the bottom of the target water region.

The cleaning path for the bottom of the target water region includes a plurality of round-trip parallel paths, and the cleaning paths for the bottom of the target water region cover the bottom of the target water region.

In one embodiment, an example in which the target water region is a pool is used. The cleaning path for the bottom of the pool includes a plurality of round-trip parallel paths, and the cleaning paths for the bottom of the pool cover the bottom of the pool. The performing path planning on the bottom of the target water region based on the contour map to obtain a cleaning path for the bottom includes: determining a shape of the bottom based on the contour map; in a case where the shape of the bottom is polygonal, determining a longest side and a shortest side of the bottom of the target water region; and determining a plurality of paths that have a target position relationship with the longest side or the shortest side of the bottom as the cleaning paths for the bottom. The target position relationship includes a parallel relationship or a perpendicular relationship. Specifically, a plurality of paths parallel to the longest side of the bottom may be determined as the cleaning paths for the bottom; or a plurality of paths parallel to the shortest side of the bottom may be determined as the cleaning paths for the bottom; or a plurality of paths perpendicular to the longest side of the bottom may be determined as the cleaning paths for the bottom; or a plurality of paths perpendicular to the shortest side of the bottom may be determined as the cleaning paths for the bottom. The longest side may be a longest straight side of a contour of the target water region or a longest inner diameter of the target water region (for example, a diameter of a circular target water region) determined based on the contour of the target water region. This is not limited herein.

In one specific embodiment, a contour map shown in FIG. 4 is used as an example. A plurality of paths approximately parallel to the longest side are planned on the contour map, and the cleaning paths cover the entire contour map. Alternatively, a contour map shown in FIG. 5 is used as an example. A plurality of paths approximately parallel to the shortest side are planned on the contour map, and the cleaning paths cover the entire contour map. Similarly, a plurality of paths approximately perpendicular to the longest side or the shortest side may be planned on the contour map. Because the cleaning paths on the contour map cover the entire contour map, the cleaning device may move to various positions at the bottom of the target water region along the cleaning paths. A cleaning member is disposed on the cleaning device, and the cleaning member cleans the bottom of the target water region in the moving process of the cleaning device, so that a technical effect of cleaning the bottom of the target water region more thoroughly can be achieved.

In one optional embodiment, in a case where a length of the longest side of the bottom of the target water region is greater than or equal to a first preset length threshold, the plurality of paths perpendicular to the longest side of the bottom of the target water region are determined as the cleaning paths for the bottom of the target water region; or in a case where a length of the shortest side of the bottom of the target water region is less than or equal to a second preset length threshold, the plurality of paths perpendicular to the shortest side of the bottom of the target water region are determined as the cleaning paths for the bottom of the target water region. The first preset length threshold and the second preset length threshold may be set based on an actual situation.

In one specific embodiment, in a case where the length of the longest side of the bottom of the target water region is too large (greater than or equal to the first preset length threshold), if a path is planned to be parallel to the longest side, a moving distance of the cleaning device on one path is too long, which may lead to a deviation in the motion of the cleaning device, affecting a cleaning effect. If a path is planned to be perpendicular to the longest side, a moving distance of the cleaning device on each path may be appropriate. Similarly, in a case where the length of the shortest side is too small (less than or equal to the second preset length threshold), if a path is planned to be parallel to the shortest side, a moving distance of the cleaning device on one path is too short, which may lead to frequent path changing, affecting cleaning efficiency. If a path is planned to be perpendicular to the shortest side, a moving distance of the cleaning device on each path may be appropriate. The length threshold is set, so that the cleaning path is not too long or too short, thereby achieving a technical effect that a moving distance of the cleaning device on each path is more reasonable.

In one optional embodiment, in a case where there is a slope at the bottom of the target water region, based on an ascending direction of the slope (namely, an upward direction of a slope surface), a plurality of paths parallel to the longest side of the bottom of the target water region are determined as the cleaning paths for the bottom of the target water region; or a plurality of paths parallel to the shortest side of the bottom of the target water region are determined as the cleaning paths for the bottom of the target water region; or a plurality of paths perpendicular to the longest side of the bottom of the target water region are determined as the cleaning paths for the bottom of the target water region; or a plurality of paths perpendicular to the shortest side of the bottom of the target water region are determined as the cleaning paths for the bottom of the target water region.

In one specific embodiment, as shown in FIG. 6, there is a slope at the bottom of the target water region, and path planning may be performed based on an ascending direction of the slope (for example, the ascending direction is a direction of EF shown in the figure). A projected direction corresponding to the ascending direction is obtained by projecting the ascending direction on a plane on which the bottom of the target water region is located. For example, a projected direction of E′F′ is obtained by projecting the direction of EF in FIG. 6 on the plane on which the bottom of the target water region is located. Based on an included angle between the projected direction and a projection of the longest side or a projection of the shortest side of the bottom of the target water region, the plurality of paths parallel to the longest side of the bottom of the target water region may be determined as the cleaning paths for the bottom of the target water region, or the plurality of paths parallel to the shortest side of the bottom of the target water region may be determined as the cleaning paths for the bottom of the target water region. In FIG. 6, the ascending direction of EF is parallel to a plane on which Y, W, T, and Q are located, and the projected direction of E′F′ corresponding to the ascending direction of EF is parallel to a projection of the longest side TQ. In this case, in FIG. 6, the included angle between the projected direction of E′F′ and the projection of the longest side is 0°. Therefore, the cleaning path for the bottom of the target water region shown in the figure is perpendicular to the longest side TQ.

In one specific embodiment, in a case where the included angle between the projected direction and the projection of the longest side is less than or equal to a first preset angle threshold, the plurality of paths perpendicular to the longest side are determined as the cleaning paths for the bottom of the target water region; or in a case where the included angle between the projected direction and the projection of the longest side is greater than the first preset angle threshold, the plurality of paths parallel to the longest side of the bottom of the target water region are determined as the cleaning paths for the bottom of the target water region; or in a case where the included angle between the projected direction and the projection of the shortest side is less than or equal to a second preset angle threshold, the plurality of paths perpendicular to the shortest side of the bottom of the target water region are determined as the cleaning paths for the bottom of the target water region; or in a case where the included angle between the projected direction and the projection of the shortest side is greater than the second preset angle threshold, the plurality of paths parallel to the shortest side of the bottom of the target water region are determined as the cleaning paths for the bottom of the target water region.

For example, the first preset angle threshold and the second preset angle threshold may be set based on an actual situation, and the first preset angle threshold and the second preset angle threshold may be equal or unequal. The slope shown in FIG. 6 is used as an example. If the included angle between the projected direction of E′F′ corresponding to the ascending direction of the slope and the projection of the longest side is 0° and less than the first preset angle threshold (which is assumed to be 45°), the cleaning path is perpendicular to the longest side; or if the included angle between the projected direction of E′F′ corresponding to the ascending direction of the slope shown in FIG. 6 and the projection of the shortest side is 90° and greater than the second preset angle threshold (which is assumed to be 40°), the cleaning path is parallel to the shortest side. In this embodiment, the projected direction corresponding to the ascending direction of the slope is obtained by projecting the ascending direction of the slope on the plane on which the bottom of the target water region is located, and path planning is performed based on the included angle between the projected direction and the projection of the longest side or the projection of the shortest side. This can reduce an amount of sliding of the cleaning device on the slope and prevent the cleaning device from sliding on the slope.

In one optional embodiment, in a case where there is a slope at the bottom of the target water region, a cleaning coverage direction may be from a high region at the bottom of the target water region (namely, a shallow end) to a low region at the bottom of the target water region (namely, a deep end). In this way, the following case can be avoided: during reverse motion (that is, moving from the deep end to the shallow end), the cleaning device needs to overcome gravity when climbing upward along the slope, and the cleaning device may slide back to the deep end due to insufficient friction between the bottom of the target water region and the cleaning device, resulting in repeated cleaning of the bottom of the deep end of the target water region, and the cleaning device fails to move to the shallow end, resulting in failing to clean the shallow end. The cleaning coverage direction is defined as a direction from the shallow end to the deep end, so that cleaning coverage over the bottom of the target water region can be improved, a cleaning repetition rate can be reduced, and cleaning efficiency can be improved.

In one optional embodiment, the performing path planning on the bottom of the target water region based on the contour map to obtain a cleaning path for the bottom of the target water region includes: segmenting a connected component from the contour map to obtain a plurality of segmented regions in the contour map; performing path planning on each of the plurality of segmented regions to obtain a cleaning path for each segmented region, where the cleaning path for each segmented region includes a plurality of round-trip parallel paths, and the cleaning paths for each segmented region cover the segmented region; and determining a plurality of cleaning paths corresponding to the plurality of segmented regions as the cleaning paths for the bottom of the target water region. Specifically, the connected component in the contour map is determined. The connected component generally refers to an image region including foreground pixels that have a same pixel value and are adjacent in an image. Connected component analysis means identifying and labeling each connected component in the image. The contour map may be segmented into a plurality of segmented regions through connected component analysis.

In one specific embodiment, the connected component may be segmented from the contour map through connected component analysis to obtain the plurality of segmented regions in the contour map. The contour map of the bottom of the target water region shown in FIG. 7 is used as an example. Region segmentation is performed on the contour map of the bottom of the target water region shown in the figure. A connected component is considered as a segmented region. The contour map shown in FIG. 7 may be segmented into regions A, B, and C. In this embodiment, because the bottom of the target water region in an actual scenario may be of various shapes, the contour map of the bottom of the target water region is segmented into a plurality of regions through connected component analysis, and path planning is performed on each segmented region. This can improve path planning efficiency.

For example, the performing path planning on each of the plurality of segmented regions to obtain a cleaning path for each segmented region includes: performing the following operations on each of the plurality of segmented regions, where a segmented region on which the following operations are performed is referred to as a current segmented region: determining a shape of the current segmented region, where the shape of the current segmented region is at least one of a polygon, a circle, and an ellipse; and performing path planning on the current segmented region based on the shape of the current segmented region to obtain a cleaning path for the current segmented region. In the actual scenario, most target water regions are quadrilateral. In a special case, there is a target water region in a shape of a circle, an ellipse, a triangle, a polygon, or the like. Because the contour map is a map of the bottom of the target water region, a shape of a segmented region obtained by segmenting the contour map may be in a shape of a circle, an ellipse, a triangle, a polygon, or the like.

In a case where the current segmented region is a polygonal region, a longest side and a shortest side of the current segmented region are determined. A plurality of paths parallel to the longest side of the current segmented region are determined as the cleaning paths for the current segmented region; or a plurality of paths parallel to the shortest side of the current segmented region are determined as the cleaning paths for the bottom of the target water region; or a plurality of paths perpendicular to the longest side of the current segmented region are determined as the cleaning paths for the bottom of the target water region; or a plurality of paths perpendicular to the shortest side of the current segmented region are determined as the cleaning paths for the bottom of the target water region.

In a case where there is a slope in the current segmented region, an ascending direction of the slope in the current segmented region is projected on a plane on which the bottom of the target water region is located to obtain a projected direction corresponding to the ascending direction of the slope. In a case where an included angle between the projected direction and a projection of the longest side of the current segmented region is less than or equal to a third preset angle threshold, the plurality of paths perpendicular to the longest side of the current segmented region are determined as the cleaning paths for the current segmented region; or in a case where the included angle between the projected direction and the projection of the longest side of the current segmented region is greater than the third preset angle threshold, the plurality of paths parallel to the longest side of the current segmented region are determined as the cleaning paths for the bottom of the target water region; or in a case where an included angle between the projected direction and a projection of the shortest side of the current segmented region is less than or equal to a fourth preset angle threshold, the plurality of paths perpendicular to the shortest side of the current segmented region are determined as the cleaning paths for the bottom of the target water region; or in a case where the included angle between the projected direction and the projection of the shortest side of the current segmented region is greater than the fourth preset angle threshold, the plurality of paths parallel to the shortest side of the current segmented region are determined as the cleaning paths for the bottom of the target water region.

The third preset angle threshold and the fourth preset angle threshold may be set based on an actual situation, and the third preset angle threshold and the fourth preset angle threshold may be equal or unequal. For example, the third preset angle threshold may be 30°, 45°, or the like, and the fourth preset angle threshold may be 30°, 40°, or the like. The projected direction corresponding to the ascending direction of the slope is obtained by projecting the ascending direction of the slope on the plane on which the bottom of the target water region is located, and path planning is performed based on the included angle between the projected direction and the projection of the longest side or the projection of the shortest side. This can reduce an amount of sliding of the cleaning device on the slope and prevent the cleaning device from sliding on the slope.

The shape of the bottom of the target water region is determined based on the contour map. In a case where the shape of the bottom of the target water region is a circle or an ellipse, a target diameter of the bottom of the target water region is determined, and a plurality of paths parallel to the target diameter are determined as the cleaning paths for the bottom of the target water region. In a case where the shape of the bottom of the target water region is a circle, any straight line is determined, and a plurality of paths parallel to the straight line are determined as the cleaning paths for the bottom of the target water region. In a case where the shape of the bottom of the target water region is an ellipse, a longest diameter of the ellipse is determined based on a minimum bounding rectangle of the ellipse, and the longest diameter is determined as the target diameter. Similarly, in a case where the current segmented region is a circular or elliptical region, the cleaning path for the current segmented region is determined in a same manner.

S36: Control the cleaning device to move along the cleaning path for the bottom of the target water region and to clean the bottom of the target water region during moving.

In one embodiment, the controlling the cleaning device to move along the cleaning path for the bottom of the target water region includes: in a case where the cleaning paths for the bottom of the target water region are parallel to the longest side or the shortest side of the bottom of the target water region, determining a path, in the cleaning paths, closest to the longest side or the shortest side of the bottom of the target water region as a first starting path on which the cleaning device moves, determining an endpoint of the first starting path as a first starting position at which the cleaning device moves, controlling the cleaning device to move from the first starting position until all cleaning paths for the bottom of the target water region are traversed or it is detected that there is an obstacle within a preset range of the cleaning device.

In one embodiment, the cleaning paths include a path close to both a current position of the cleaning device and the boundary of the bottom of the target water region, the path is determined as a second starting path on which the cleaning device moves, and an endpoint of the second starting path is determined as a second starting position at which the cleaning device moves. The cleaning device is controlled to move from the second starting position until all cleaning paths for the bottom of the target water region are traversed or it is detected that there is an obstacle within the preset range of the cleaning device. FIG. 18 is a schematic diagram of a fifth embodiment of path planning according to this application. As shown in FIG. 18, a current position point of the cleaning device is A, and cleaning paths 1 and 2 are both close to the boundary of the bottom of the target water region. The cleaning path 1 is closer to the position point A, so the cleaning path 1 is determined as the second starting path, and an endpoint B of the cleaning path 1 is determined as the second starting position. In this way, after completing moving along the edge, the cleaning device can continue to move along the cleaning path without moving for an excessively long distance. This improves operation efficiency of the cleaning device. In addition, because the second starting path is close to the boundary of the bottom of the target water region, the endpoint of the second starting path is generally located near a corner at the bottom of the target water region. In this case, the endpoint of the second starting path is determined as the second starting position at which the cleaning device moves, so that the cleaning device moves from the corner at the bottom of the target water region. In this way, the cleaning device is prevented from moving along the cleaning path from a middle position of the path, thereby reducing reciprocating motion necessary to cover all cleaning paths. This helps reduce power consumption of the cleaning device and improve the operation efficiency of the cleaning device.

A first path and a second path are two adjacent paths in the plurality of segmented regions. The cleaning device is controlled to move from a starting point of the first path to an ending point of the first path. An endpoint of the second path is closest to the ending point of the first path, and the endpoint is determined as a starting point of the second path. The cleaning device is controlled to move from the ending point of the first path to the starting point of the second path, and the cleaning device is controlled to move from the starting point of the second path to an ending point of the second path.

Controlling the cleaning device to move from the ending point of the first path to the starting point of the second path includes, but is not limited to, determining a target angle based on an included angle between the first path and a connection line between the ending point of the first path and the starting point of the second path; determining a distance between the ending point of the first path and the starting point of the second path as a target distance; and when the cleaning device reaches the ending point of the first path, controlling the cleaning device to rotate by the target angle and move for the target distance to reach the starting point of the second path.

In the above manner, the cleaning device moves from the first cleaning path based on the cleaning paths and starts to perform cleaning along the cleaning paths. The pool shown in FIG. 6 is used as an example. Dashed lines in the figure are the cleaning paths, and the cleaning device is controlled to move along the cleaning paths in a direction from E to F in the figure, to move from a boundary of TH to a boundary of QG of the bottom of the target water region or move from the boundary of QG to the boundary of TH of the bottom of the target water region. EF indicates the slope at the bottom of the target water region. When the cleaning device traverses all the cleaning paths, cleaning of the bottom is completed.

The contour map of the bottom of the target water region is constructed based on the boundary information of the bottom of the target water region; region segmentation is performed on the contour map to obtain the plurality of segmented regions in the contour map; path planning is performed on each of the plurality of segmented region to obtain a cleaning path for each segmented region; and the cleaning device is controlled to move along the cleaning path. In this way, the cleaning device can move along the cleaning path to clean the bottom of the target water region. Therefore, a problem of low efficiency in manually cleaning the target water region can be resolved, and the cleaning efficiency of the target water region can be improved.

Optionally, the cleaning device may perform path planning on the target water region without depending on the contour map.

In one optional embodiment, performing path planning on the target water region without depending on the contour map may include the following steps. The cleaning device searches for a relatively longest path at the bottom or the water surface of the target water region and performs path planning based on the longest path. This improves the cleaning coverage. The relatively longest path is a longest path obtained by the cleaning device during searching, and may be an actual longest path at the bottom or the water surface of the target water region, such as a diagonal line in a square target water region, or may be any path smaller than the actual longest path.

In one specific embodiment, a manner in which the cleaning device searches for a relatively longest path at the bottom or the water surface of the target water region may include the following steps. The cleaning device moves in any direction, for example, in a crisscrossing manner, obtains a longest path in the target water region searched within a preset quantity of motions or within preset moving duration, and determines the path as the relatively longest path.

In one specific embodiment, a path obtained by performing path planning based on the relatively longest path may be parallel to the relatively longest path, or there is a preset included angle between the cleaning path and the relatively longest path. For example, the cleaning path is perpendicular to the relatively longest path. A quantity of cleaning paths may be determined based on a length of the relatively longest path.

In one optional embodiment, when cleaning is completed along the cleaning path, the cleaning device may rotate by a preset angle (for example, 45°) at a position at which cleaning is completed, and then repeat the process of searching for a relatively longest path at the bottom or the water surface of the target water region to perform path planning, thereby improving the cleaning coverage.

In one optional embodiment, when a current relatively longest path is obtained through the process of obtaining a relatively longest path, the cleaning device may rotate by a preset angle (for example, 45°) at an ending position, and then repeat the process of obtaining a relatively longest path to obtain a next relatively longest path. A longer path is selected from the current relatively longest path and the next relatively longest path as a final relatively longest path for subsequent path planning, thereby improving path planning accuracy.

FIG. 19 is a schematic diagram of an embodiment of a relatively longest path according to this application. As shown in FIG. 19, the cleaning device moves in a direction. A motion path in the direction is denoted as AB. There may be a plurality of motion paths in a vertical direction of the path AB, and a longest path is selected and denoted as CD. The above steps may be repeated. For example, the cleaning device continues to move in a vertical direction of the path CD to obtain a longest path which is denoted as EF. After the cleaning device finishes moving, the searched longest path is determined as the relatively longest path. For example, if the path CD in the figure is the longest path in all searched paths, the path CD is determined as the relatively longest path.

In one optional embodiment, performing path planning on the target water region without depending on the contour map may include the following steps. The cleaning device moves in any direction until a detected water depth is less than a first preset threshold, indicating that the cleaning device may be located in the shallow end or at a wall of the target water region at this time. The cleaning device may adjust the moving direction to be separated from the wall or adjust the moving direction until the detected water depth is greater than or equal to a second preset threshold, where the second preset threshold is greater than or equal to the first preset threshold. The cleaning device rotates to any direction in any rotation manner. The above steps are repeated until a preset stopping condition such as time or a quantity of motions is met. According to the above manner, both the bottom and the wall of the target water region can be cleaned, and both the deep end and the shallow end can also be cleaned. This improves the cleaning efficiency.

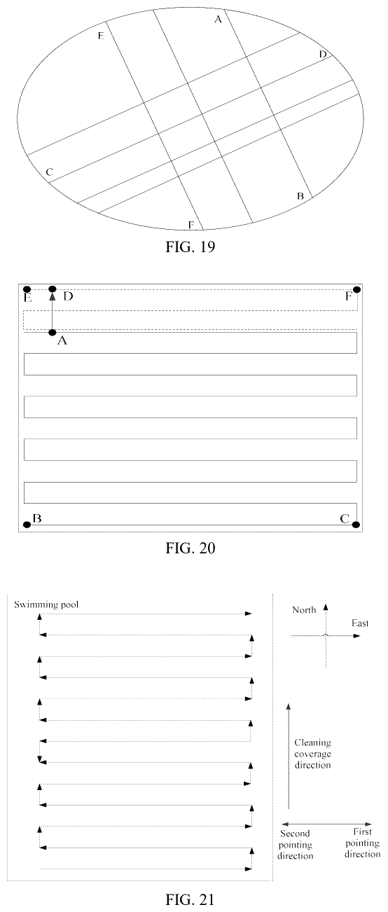

In one optional embodiment, after the cleaning device has completed moving along the cleaning paths and performs cleaning during moving, the cleaning device may move in a direction away from the starting path in the cleaning paths until the cleaning device moves for a preset distance, the cleaning device is in contact with the wall, or there is a preset distance between the cleaning device and the wall. Then, the cleaning device moves toward the cleaning path to perform supplementary cleaning. A supplementary cleaning path may be planned. A mode of the supplementary cleaning path may be the same as that of the cleaning path. For example, both are a bow-shaped path (the bow-shaped path means that two adjacent paths are parallel to each other, and the cleaning device moves along the two adjacent paths in two opposite forward directions). Alternatively, the mode of the supplementary cleaning path may be different from that of the cleaning path. For example, the cleaning path is a bow-shaped path, and the supplementary cleaning path is an N-shaped path. The supplementary cleaning path is added, so that the following problem can be avoided: in the moving process of the cleaning device, an actual motion path of the cleaning device deviates from the cleaning path due to a positioning error, an external force, and the like, thus causing some regions to fail to be cleaned. This improves the overall cleaning coverage and improves the cleaning effect of the cleaning device. FIG. 20 is a schematic diagram of a sixth embodiment of path planning according to this application. As shown in FIG. 20, when the cleaning device moves along the cleaning path, an actual ending position is A. Then, the cleaning device may move from the ending position in a direction away from a starting path BC in the cleaning paths until there is a preset distance between the cleaning device and the wall, and a path (indicated by a dashed line in the figure) from a stopping position D toward the starting path BC is planned. For example, the cleaning device moves from a path EF to the starting path BC and performs cleaning during moving.

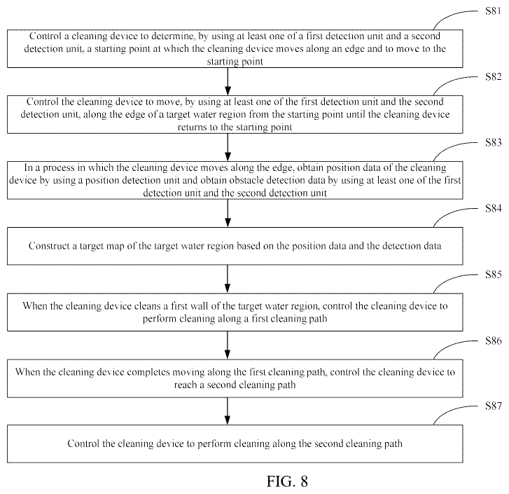

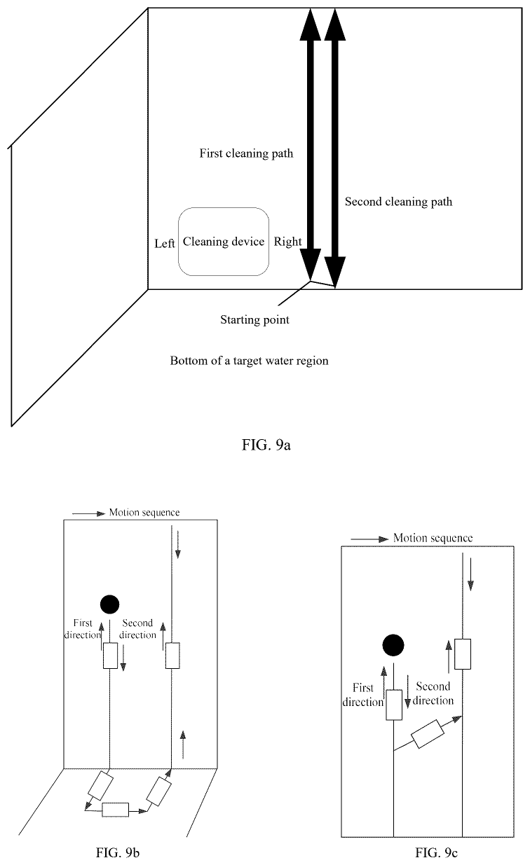

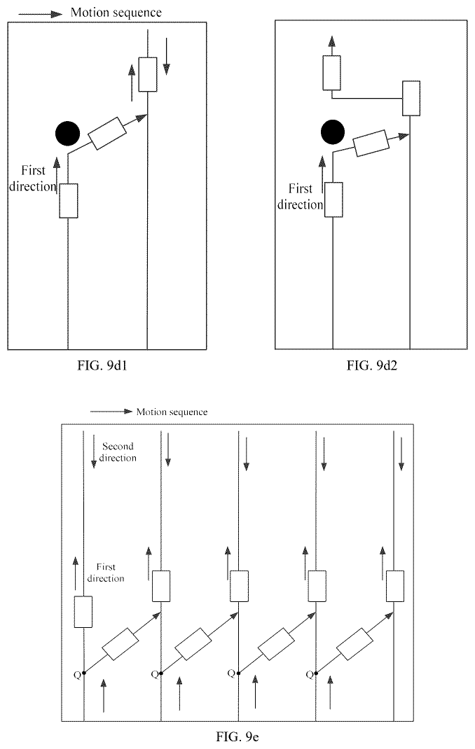

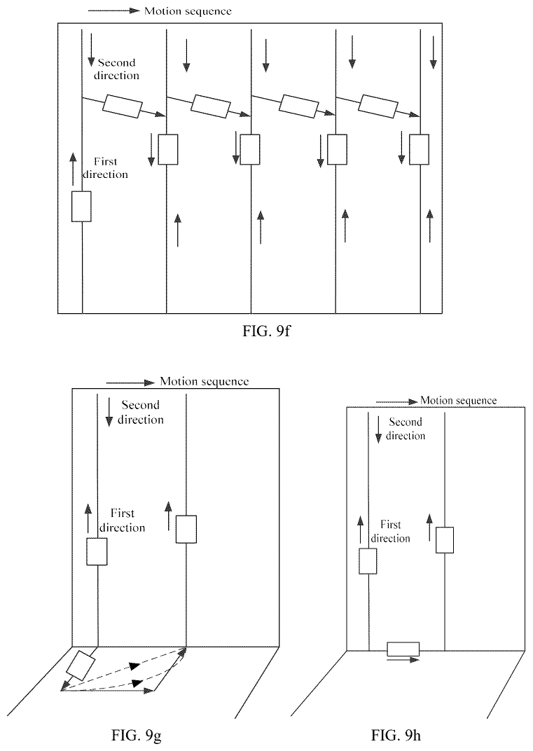

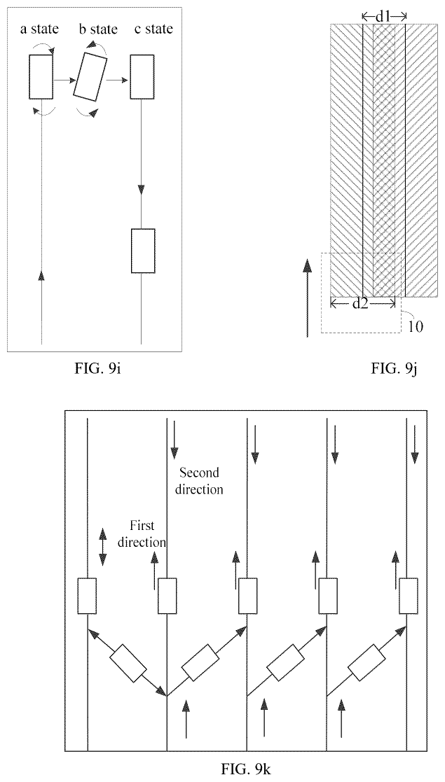

Refer to FIG. 8 and FIG. 9a. FIG. 8 is a schematic flowchart of a fourth embodiment of a cleaning device control method according to this application. FIG. 9a is a schematic diagram of a first embodiment of a first cleaning path and a second cleaning path according to this application. The method includes the following steps.

S81: Control a cleaning device to determine, by using at least one of a first detection unit and a second detection unit, a starting point at which the cleaning device moves along an edge and to move to the starting point.

S82: Control the cleaning device to move, by using at least one of the first detection unit and the second detection unit, along the edge of a target water region from the starting point until the cleaning device returns to the starting point.

S83: In a process in which the cleaning device moves along the edge, obtain position data of the cleaning device by using a position detection unit and obtain obstacle detection data by using at least one of the first detection unit and the second detection unit.

S84: Construct a target map of the target water region based on the position data and the detection data.

In one embodiment, the target map includes a map of a wall of the target water region. For specific implementation of steps S81 to S84, refer to related descriptions of the first embodiment of the cleaning device control method provided in this application. Details are not described herein again.

S85: When the cleaning device cleans a first wall of the target water region, control the cleaning device to perform cleaning along a first cleaning path.

In this embodiment, the cleaning device control method is a method for controlling a cleaning device to cleaning a wall.

In one embodiment, the target water region may be a polygonal swimming pool (namely, a swimming pool including a plurality of walls). The first wall may be any wall of the swimming pool. The first cleaning path may be located on a wall or the bottom of the swimming pool or a water surface. An example in which the first cleaning path is located on the first wall is used. The first cleaning path may be parallel to a connection line between the first wall and a second wall. It may be understood that the first cleaning path may alternatively not be parallel to the connection line between the first wall and the second wall. The first cleaning path may be the 1^{st} cleaning path on a wall, a path with a higher execution priority in two different cleaning paths which are on a same wall, or a path with a higher execution priority in two different cleaning paths which are on different walls.

In one embodiment, the cleaning device is controlled to move along the first cleaning path in a first direction. The first direction may be a direction from the bottom of the target water region to the water surface of the target water region. A pressure sensor disposed on the cleaning device is configured to detect whether the cleaning device reaches the water surface. If the cleaning device reaches the water surface of the target water region, the cleaning device is controlled to move along the first cleaning path in a second direction. The second direction is a direction from the water surface of the target water region to the bottom of the target water region. That the cleaning device reaches the water surface of the target water region may be that the cleaning device is close to or at least partially exposed at a waterline. It should be noted that for the first wall of different shapes, the first direction may be different. Specifically, when the first wall is vertical, the first direction may be a vertical direction or a tilting direction. FIG. 23 is a schematic diagram of a fifth embodiment of a first cleaning path according to this application. As shown in the FIG. 23, if the first direction is the tilting direction, the first cleaning path tilts on the first wall. In some embodiments, an included angle between the first direction and a bottom side of the first wall is greater than 30°. When the first wall is curved, the first direction may vary based on a specific position of the cleaning device on the first wall and a curvature degree of the first wall at this position. The same applies to the second direction. In some embodiments, the first direction is a direction in which the cleaning device moves from the bottom of the first wall to the waterline at the first wall, and the second direction is a direction in which the cleaning device moves from the waterline at the first wall to the bottom of the first wall. When the cleaning device is controlled to move on the first wall in the first direction or the second direction, the cleaning device may be at least partially in contact with the first wall or may be not in contact with the first wall.

In one embodiment, the cleaning device is controlled to move along the first cleaning path in a first direction. The first direction may be a direction from the bottom of a wall of the target water region to the top of the wall of the target water region. If the cleaning device reaches the top of the wall of the target water region, the cleaning device is controlled to move along the first cleaning path in a second direction. The second direction is a direction from the top of the wall of the target water region to the bottom of the wall of the target water region.

In one embodiment, in a case where an obstacle is detected in a process in which the cleaning device moves along the first cleaning path in the first direction, the cleaning device may be controlled to move along the first cleaning path in the second direction. FIG. 9b is a schematic diagram of a first embodiment of a first cleaning path according to this application. As shown in FIG. 9b, when the cleaning device encounters an obstacle during moving in the first direction, the cleaning device may perform an obstacle avoidance action. For example, the cleaning device may first move from the first wall to the bottom of the target water region in the second direction. After reaching the bottom of the target water region, the cleaning device adjusts a moving direction and moves from the bottom of the target water region to the first wall. Then, the cleaning device continues to move on the first wall along a path (which may be a second cleaning path or another cleaning path) different from the first cleaning path. FIG. 9c is a schematic diagram of a second embodiment of a first cleaning path according to this application. As shown in FIG. 9c, when the cleaning device encounters an obstacle during moving in the first direction, the cleaning device may perform an obstacle avoidance action. For example, the cleaning device may be controlled to rotate by a preset angle along the first cleaning path to a third direction, move for a certain distance or duration to a path different from the first cleaning path, rotate to a path substantially parallel to the first cleaning path again, and continue to move along the path in the first direction or the second direction.

In one embodiment, in a case where an obstacle is detected in a process in which the cleaning device moves along the first cleaning path in the first direction, the cleaning device may be controlled to move along the path in the second direction for a preset distance or duration and then rotate by a preset angle. FIG. 9d1 is a schematic diagram of a third embodiment of a first cleaning path according to this application. As shown in FIG. 9d1, when the cleaning device encounters an obstacle during moving in the first direction, the cleaning device may perform an obstacle avoidance action. For example, the cleaning device may decelerate, move backward or turn around, and move for a preset distance. Then, the cleaning device rotates by a preset angle on the first wall and moves for a certain distance in a direction after rotation to a path different from the first cleaning path. The cleaning device rotates to a path substantially parallel to the first cleaning path again and continues to move along the path in the first direction or the second direction.

In another embodiment, in a case where an obstacle is detected in a process in which the cleaning device moves along the first cleaning path in the first direction, the cleaning device may perform an obstacle avoidance action. For example, the cleaning device may be controlled to leave the first cleaning path to avoid the obstacle and after avoiding the obstacle, the cleaning device returns to and continues to move along the first cleaning path. FIG. 9d2 is a schematic diagram of a fourth embodiment of a first cleaning path according to this application. As shown in FIG. 9d2, after the cleaning device avoids the obstacle on the first cleaning path, the cleaning device returns to and continues to move along the first cleaning path.

In the above embodiment, an obstacle may be detected by using a sensor disposed on the cleaning device or based on information of a collision between the cleaning device and the obstacle.

In one embodiment, when the cleaning device moves to the water surface along the first cleaning path in the first direction, the cleaning device may be controlled to turn around and move along the first cleaning path in the second direction, or the cleaning device may be controlled to move backward along the first cleaning path, so that the cleaning device moves along the first cleaning path in the second direction. The cleaning device moves backward without turning around. Therefore, time can be reduced.

In a case where it is detected that the cleaning device reaches the water surface of the target water region, after the cleaning device is controlled to stay for preset duration (the preset duration may be determined based on an actual situation, for example, 3 seconds) at a position at which the cleaning device reaches the water surface, the cleaning device is controlled to move along the first cleaning path in the second direction. The cleaning device is provided with a cleaning member, such as a cleaning roller brush (the cleaning roller brush may be disposed at a front portion of the cleaning device). When the cleaning device reaches the water surface, the cleaning roller brush at the front portion of the cleaning device is located at a waterline, so that the waterline can be cleaned within the preset duration for which the cleaning device stays at the position.

In one embodiment, controlling the cleaning device to clean the waterline of the target water region within the preset duration includes: controlling the cleaning device to sequentially move in two opposite directions at the waterline of the target water region within the preset duration to scrub a wall at the waterline. This improves a waterline cleaning effect.

In one embodiment, in a case where it is detected that the cleaning device reaches the water surface of the target water region, after the cleaning device is controlled to sequentially move in two opposite directions at the waterline of the target water region for a preset quantity of times, the cleaning device is controlled to move along the first cleaning path in the second direction.

In a process of moving from the bottom of the target water region to the water surface along the first cleaning path, water pressure in the target water region is collected by the pressure sensor, and a threshold may be preset (a specific value is set based on an actual situation). In a case where pressure sensing data collected by the pressure sensor is less than or equal to the preset threshold, it is determined that the cleaning device moves to the water surface. In other embodiments, a sensor, for example, a moving wheel, a code disk, or an IMU, that can record a moving distance of the cleaning device may be disposed to determine whether the cleaning device moves to the water surface, or a sensor for detecting whether some components of the cleaning device are exposed at the water surface may be disposed to determine whether the cleaning device moves to the water surface. When the cleaning device moves to the water surface, the cleaning device moves from the water surface to the bottom of the target water region along the first cleaning path. When the cleaning device moves to the bottom of the target water region, it is determined that the cleaning device completes moving along the first cleaning path, that is, the cleaning device completes performing cleaning along the first cleaning path.

In one embodiment, when the cleaning device moves along the first cleaning path in the first direction to the top of the wall of the target water region, the cleaning device may be controlled to turn around and move along the first cleaning path in the second direction, or the cleaning device may be controlled to move backward along the first cleaning path, so that the cleaning device moves along the first cleaning path in the second direction. The cleaning device moves backward without turning around. Therefore, time can be reduced.

Based on this step, because the cleaning device moves twice along the same path in two different directions, cleaning can be performed twice along the path. This improves cleaning strength and improves cleanliness of the swimming pool.

S86: When the cleaning device completes moving along the first cleaning path, control the cleaning device to reach a second cleaning path.

The second cleaning path is substantially parallel to the first cleaning path, and the second cleaning path is adjacent to the first cleaning path. The second cleaning path may be the 2^{nd} cleaning path on a wall, a path with an execution priority lower than that of the first cleaning path, where the second cleaning path and the first cleaning path are on a same wall, or a path with an execution priority lower than that of the first cleaning path, where the second cleaning path and the first cleaning path are on different walls.

In a case where the cleaning device is controlled to move to the bottom of the target water region along the first cleaning path in the second direction, it is determined that the cleaning device completes moving along the first cleaning path. That the cleaning device moves to the bottom of the target water region in the second direction may be that the cleaning device moves to the bottom of the first wall in the second direction, and at least a part of the cleaning device is close to or in contact with the bottom of the target water region, or the cleaning device moves in the second direction until at least a part of the cleaning device leaves the first wall, and the bottom of the cleaning device is in contact with the bottom of the target water region. A target sensor (the target sensor may be a sensor capable of detecting a collision, for example, an inertial measurement unit or a collision sensor, or may be a sensor capable of detecting a distance, for example, an ultrasonic sensor or a laser sensor) may be disposed on the front portion or a rear portion of the cleaning device. The target sensor disposed on the front portion of the cleaning device may be configured to detect, when the cleaning device moves forward, whether the front portion of the cleaning device is hit or whether there is an obstacle in front of the cleaning device. The target sensor disposed on the rear portion of the cleaning device may be configured to detect, when the cleaning device moves backward, whether the rear portion of the cleaning device is hit or whether there is an obstacle at the rear of the cleaning device.

For example, the inertial measurement unit may determine, based on a sudden change in an acceleration, that the cleaning device collides with the bottom of the target water region or determine that the cleaning device collides with an obstacle. If the target sensor detects that the cleaning device collides with the bottom of the target water region, it is determined that the cleaning device reaches the bottom of the target water region. In this case, the cleaning device needs to be controlled to change a path, and the cleaning device is controlled to reach the second cleaning path adjacent to the first cleaning path to complete performing cleaning along the second cleaning path. Alternatively, when a distance sensor (for example, an ultrasonic sensor) detects that a distance between the cleaning device and the bottom of the target water region reaches a preset distance threshold (which may be set based on an actual situation, for example, 0.2 meters or 0.3 meters), it is determined that the cleaning device reaches the bottom of the target water region. In other words, in a case where the cleaning device is close to the bottom of the target water region, but does not collide with the bottom of the target water region, the cleaning device completes moving along the first cleaning path and moves to the second cleaning path, to complete performing cleaning along the second cleaning path. Alternatively, whether the cleaning device reaches the bottom of the target water region may be determined based on attitude angles of the cleaning device and by using the distance sensor. The attitude angles include a pitch angle (Pitch), a yaw angle (Yaw) and a roll angle (Roll), which respectively indicate rotation angles by which the cleaning device rotates around three coordinate axes of a coordinate system: X-axis, Y-axis and Z-axis. When a change in the pitch angle of the cleaning device on the first wall is equal to a preset angle threshold, or the pitch angle of the cleaning device on the first wall is less than a preset angle threshold, it is determined that the cleaning device reaches the bottom of the target water region. Alternatively, when the cleaning device collides with the bottom of the target water region, or the pitch angle is less than the preset threshold, or when the distance between the cleaning device and the bottom of the target water region reaches the preset distance threshold, or the pitch angle is less than the preset threshold, it is determined that the cleaning device reaches the bottom of the target water region. In a case where the bottom of the target water region is of a non-right-angle shape, such as a circular arc shape, whether the cleaning device reaches the bottom of the target water region is determined only based on whether the cleaning device collides with the bottom of the cleaning device or only based on the distance between the cleaning device and the obstacle, a bottom corner of a wall of the target water region may be determined as the bottom of the target water region. Consequently, the cleaning device may move in the first direction before reaching the bottom of the target water region, leading to a possibility of missed cleaning. The above manner improves accuracy of determining whether the cleaning device reaches the bottom of the target water region and further improves the cleaning coverage.

In one embodiment, in a case where the cleaning device is controlled to move along the first cleaning path in the first direction to the water surface of the target water region or the top of the first wall, it is determined that the cleaning device completes moving along the first cleaning path.

In one embodiment, it is determined that the cleaning device moves to the bottom of the target water region when one or more of the following conditions are met: the cleaning device collides with the bottom of the target water region; the change in the pitch angle of the cleaning device on the first wall is equal to the preset angle threshold; the distance between the cleaning device and the bottom of the target water region reaches the preset distance threshold; and the pitch angle of the cleaning device on the first wall is less than a sixth preset angle threshold.

S87: Control the cleaning device to perform cleaning along the second cleaning path.

In one embodiment, steps S85 to S87 may be independently implemented without combining with steps S81 to S84.

In one embodiment, after completing performing cleaning along the first cleaning path on the first wall, the cleaning device may move directly to the second cleaning path on the first wall without moving to the bottom of the target water region for path switching. This improves path switching efficiency.

For example, the cleaning device may be controlled to move to the second cleaning path in the following manner. As shown in FIG. 9a, the cleaning device is controlled to rotate by a first preset angle. The first preset angle may be set based on an actual situation, for example, 10° or 15°. After the cleaning device rotates by the first preset angle, the cleaning device is controlled to move for a preset distance. The preset distance may be set based on actual situation, for example, 0.2 meters or 0.3 meters. A position at which the cleaning device arrives after moving for the preset distance is determined as a starting point of the second cleaning path. The second cleaning path shown in FIG. 9a is located to the left of the first cleaning path. Alternatively, the second cleaning path may be located to the right of the first cleaning path. Cleaning is repeatedly performed in a manner of performing cleaning along the first cleaning path and the second cleaning path until cleaning of the first wall is completed.

The cleaning device may alternatively be controlled to move to the second cleaning path in the following manner. When the cleaning device completes moving along the first cleaning path, the cleaning device is controlled to move along the first cleaning path for a seven preset distance (namely, a first target preset distance) in the first direction. After the cleaning device moves for the seven preset distance, the cleaning device is controlled to rotate by a second preset angle and move for preset duration or a third preset distance (namely, a second target preset distance) to reach the starting point of the second cleaning path.

The seventh preset distance may be set based on an actual situation, for example, 0.1 meters or 0.2 meters. The third preset distance may be set based on an actual situation, for example, 0.2 meters or 0.3 meters. FIG. 9 e is a schematic diagram of a second embodiment of a first cleaning path and a second cleaning path according to this application. As shown in FIG. 9e, after the cleaning device completes moving along the first cleaning path, the cleaning device moves upward for the seven preset distance along the first cleaning path, rotates by the second preset angle, and then moves for the third preset distance to reach the starting point of the second cleaning path. The cleaning device moves upward for a preset distance to leave space for the cleaning device to rotate. According to the above moving manner, the cleaning device can switch paths without leaving the wall, and the cleaning device only needs to perform simple actions such as moving forward, moving backward, and deflecting by the second preset angle. This reduces energy consumption of the cleaning device and a motion error rate, and improves motion efficiency and cleaning efficiency of the cleaning device. In addition, the cleaning device moves upward along the first cleaning path for the seventh preset distance, rotates by the second preset angle, and then moves for the third preset distance to reach the starting point of the second cleaning path, so that the cleaning device moves from a non-endpoint position of the first cleaning path to a non-endpoint position of the second cleaning path. This reduces a moving distance of the cleaning device after the cleaning device rotates by a certain angle, reduces a motion deviation on the wall due to factors such as difficulty in controlling motion, improves motion accuracy of the cleaning device, reduces a possibility of missed cleaning, and ensures cleaning coverage over the wall of the target water region.

In one optional embodiment, a position at which the cleaning device moves from one cleaning path to a starting position of another cleaning path is defined as a path switching position. As shown in FIG. 9e, the cleaning device moves from the first cleaning path to the second cleaning path, and a position Q is a path switching position on the first cleaning path. The path switching position may be determined based on a condition that the path switching position is away from the bottom of a wall of the target water region and a waterline of the target water region and/or the attitude angles of the cleaning device. For example, when a distance between the cleaning device and the bottom of the wall of the target water region and a distance between the cleaning device and the waterline of the target water region are greater than 0, or the pitch angle of the cleaning device meets a preset condition (for example, the pitch angle is greater than or equal to 60°), or a distance between the cleaning device and the water surface of the target water region meets a preset distance requirement (that is, a water depth of a position at which the cleaning device is located is within a preset range), the position can be used as the switching position of the cleaning path. In a case where the bottom of the target water region is of a non-right-angle shape, if the switching position is determined only based on the distance between the cleaning device and the bottom of the target water region, a bottom corner of a wall of the target water region may be determined as the bottom of the target water region, resulting in an error in determining the switching position. Consequently, when the cleaning device switches a cleaning path at the circular arc-shaped bottom of the target water region, the cleaning device may slip, affecting path switching. The switching position is determined based on the attitudes angle of the cleaning device or the distance between the cleaning device and the water surface of the target water region, so that the above problem can be avoided. This improves path switching accuracy of the cleaning device.

The cleaning device may alternatively be controlled to move to the second cleaning path in the following manner. When the cleaning device completes moving along the first cleaning path, the cleaning device is controlled to move along the first cleaning path for a fourth preset distance in the second direction. After the cleaning device moves for the fourth preset distance, the cleaning device is controlled to rotate by a third preset angle and move for a fifth preset distance to reach the starting point of the second cleaning path.

The fourth preset distance and the fifth preset distance may be set based on an actual situation, for example, 0.1 meters, 0.2 meters, or 0.3 meters. FIG. 9f is a schematic diagram of a third embodiment of a first cleaning path and a second cleaning path according to this application. As shown in FIG. 9f, after the cleaning device completes moving along the first cleaning path, the cleaning device moves downward from the top of the first cleaning path along the first cleaning path for the fourth preset distance, rotates by the third preset angle, and then moves for the fifth preset distance to reach the starting point of the second cleaning path.

The cleaning device may alternatively be controlled to move to the second cleaning path in the following manner. When the cleaning device completes moving along the first cleaning path, the cleaning device is controlled to move from the first wall to the bottom of the target water region. After the cleaning device reaches the bottom of the target water region, the cleaning device adjusts a moving direction and then move from the bottom of the target water region to the first wall to reach the starting point of the second cleaning path. The cleaning device may move from the bottom of the target water region to the first wall based on any trajectory. FIG. 9g is a schematic diagram of a fourth embodiment of a first cleaning path and a second cleaning path according to this application. As shown in FIG. 9g, the cleaning device may move from the bottom of the target water region to the first wall along any one or more of the following trajectories: a straight trajectory, a curved trajectory, or a zigzag trajectory.

The cleaning device may alternatively be controlled to move to the second cleaning path in the following manner. When the cleaning device completes moving along the first cleaning path, the cleaning device is controlled to rotate by a fourth preset angle and move for a sixth preset distance to reach the starting point of the second cleaning path. FIG. 9h is a schematic diagram of a fifth embodiment of a first cleaning path and a second cleaning path according to this application. As shown in FIG. 9h, the cleaning device may rotate by the fourth preset angle at a position close to the bottom of the first wall and move for the sixth preset distance to reach the starting point of the second cleaning path. The position close to the bottom of the first wall may be a position at which the bottom of the first wall is connected to the bottom of the target water region.

The cleaning device may alternatively be controlled to move to the second cleaning path in the following manner. When the cleaning device completes moving along the first cleaning path, the cleaning device is controlled to move in a horizontally twisting manner and gradually moves away from the first cleaning path until the cleaning device reaches the starting point of the second cleaning path. FIG. 9i is a schematic diagram of a sixth embodiment of a first cleaning path and a second cleaning path according to this application. As shown in FIG. 9i, when the cleaning device completes moving along the first cleaning path (in this case, the cleaning device is in an a state), a head portion of the cleaning device first twists clockwise and then counterclockwise or first twists counterclockwise and then clockwise to move toward the second cleaning path (in this case, the cleaning device is in a b state). During this process, the cleaning device continuously adjusts its position until the cleaning device reaches the starting point of the second cleaning path. In this case, the cleaning device adjusts its posture to an operation posture (in this case, the cleaning device is in a c state), to continue to perform a cleaning task. The c state may be the same as or different from the a state. Certainly, a manner in which the cleaning device moves away from the first cleaning path is not limited to a horizontally twisting manner and may be another manner. For example, after moving in the first direction to an ending point of the first cleaning path, the cleaning device may horizontally translate for a certain distance in a direction perpendicular or approximately perpendicular to the first direction to reach the starting point of the second cleaning path. After completing horizontal translation, the cleaning device stays the same or rotates by a certain angle and adjusts its posture to the operation posture. Then, the cleaning device turns around or moves backward and continues to move in the second direction. In a case where the cleaning device moves along the first cleaning path to the water surface of the target water region, it is determined that the cleaning device completes moving along the first cleaning path. The above horizontally twisting process may be implemented by applying different driving forces to moving wheels or tracks on both sides of the cleaning device. For example, in a case where a greater driving force is applied to moving wheels or a track on a left side of the cleaning device, the cleaning device is in a b state shown in FIG. 9i.

In some embodiments, FIG. 9j is a schematic diagram of a seventh embodiment of a first cleaning path and a second cleaning path according to this application. As shown in FIG. 9j, a distance d1 between a center of the first cleaning path and a center of the second cleaning path may be less than an operation width d2 of the cleaning device 150, so that a part between the two adjacent paths can be covered and cleaned by the cleaning device to ensure the cleaning coverage.

In one embodiment, the first wall is used as an example. In a process of moving from the first cleaning path to the second cleaning path, if the pitch angle of the cleaning device is less than a certain angle threshold, or the cleaning device cannot move from the path switching position to the starting position of the second cleaning path within preset duration, or a depth of the cleaning device in the target water region is less than a preset depth threshold, the cleaning device moves to the bottom of the target water region or the water surface of the target water region and returns to the first wall after moving for a certain distance. In this way, the following case can be avoided: the cleaning device fails to move from the first cleaning path to the second cleaning path, causing the cleaning device to stop cleaning the wall. This improves the cleaning efficiency of the cleaning device.

A target sensor may be provided on a left side portion or a right side portion of the cleaning device, and whether the cleaning device collides with a wall is detected by the target sensor. When the cleaning device completes cleaning the first wall, the cleaning device is controlled to move to a second wall adjacent to the first wall. Specifically, whether the cleaning device collides with the second wall is detected by the target sensor disposed on the cleaning device. In a case where it is determined that the cleaning device collides with the second wall, it is determined that the cleaning device completes cleaning the first wall, and the cleaning device is controlled to move to the second wall to clean the second wall. Alternatively, whether there is an obstacle to the left or the right of the cleaning device is detected by the target sensor. In a case where it is determined that there is an obstacle, it is determined that the cleaning device completes cleaning the first wall, and the cleaning device is controlled to move to the second wall to clean the second wall.

The cleaning device is controlled to move from the first wall to the second wall in the following manner: controlling the cleaning device to move from the first wall to the bottom of the target water region, and after the cleaning device reaches the bottom of the target water region, controlling the cleaning device to move to the second wall. After the cleaning device reaches the second wall, the cleaning device moves in a manner in the above embodiment to clean the second wall.

For example, as shown in FIG. 9a, the second cleaning path is located to the left of the first cleaning path, and the second wall is located to the left of the first wall. In this case, whether a left side portion of the cleaning device is hit is detected by the target sensor. In a case where it is determined that the left side portion of the cleaning device is hit, it is determined that the cleaning device completes cleaning the first wall, and the cleaning device is controlled to move to the second wall located to the left of the cleaning device to clean the second wall. Alternatively, whether there is an obstacle to the left of the cleaning device is detected by the target sensor. In a case where it is determined that there is an obstacle, it is determined that the cleaning device completes cleaning the first wall, and the cleaning device is controlled to move to the second wall to clean the second wall.

In another optional embodiment, the second wall may be located to the right of the first wall. For a manner of controlling the cleaning device to move from the first wall to the second wall, refer to descriptions of the second wall located to the left of the first wall. Details are not described herein again.

In one optional embodiment, after the cleaning device moves from the first wall to the second wall, a supplementary cleaning action may be performed preferentially. The cleaning device first moves and performs cleaning in a direction opposite to a cleaning path, and then returns to the cleaning path. FIG. 9k is a schematic diagram of an eighth embodiment of a first cleaning path and a second cleaning path according to this application. As shown in FIG. 9k, in a case where the second cleaning path is located to the right of the first cleaning path, the cleaning device may first move to the left before moving along the cleaning path. A moving manner may be the same as a manner in which the cleaning device moves from the first cleaning path to the second cleaning path. For example, the first cleaning path is located on the second wall, and the cleaning device is controlled to move along the first cleaning path on the second wall for a seventh preset distance in the first direction. After the cleaning device moves for the seventh preset distance, the cleaning device is controlled to rotate to the left by the second preset angle and move for an eighth preset distance. A moving manner may alternatively be different from the manner in which the cleaning device moves from the first cleaning path to the second cleaning path. This is not limited herein. After the cleaning device finishes supplementary cleaning, the cleaning device may move backward along an original path and return to the first cleaning path, or return to the first cleaning path in another manner to clean the second wall subsequently. FIG. 9l is a schematic diagram of a ninth embodiment of a first cleaning path and a second cleaning path according to this application. As shown in FIG. 9l, after the cleaning device finishes supplementary cleaning, the cleaning device is controlled to move along a supplementary cleaning path in the first direction fort a preset distance, rotate by a preset angle, and move for a preset distance to reach the starting point of the first cleaning path. Supplementary cleaning is performed, so that the following problem can be resolved: after moving from the first wall to the second wall, the cleaning device fails to clean a corner of the second wall, causing a cleaning blind zone on the wall of the target water region. This improves the cleaning coverage over the wall of the target water region.

The cleaning device is controlled to move along the first cleaning path sequentially in two opposite directions. When the cleaning device completes moving along the first cleaning path, the cleaning device is controlled to reach the second cleaning path, the second cleaning path is parallel to the first cleaning path, and the second cleaning path is adjacent to the first cleaning path. The cleaning device is controlled to move along the second cleaning path sequentially in two opposite directions. In this way, the cleaning device can move along the above paths to clean a wall of the target water region. Therefore, a problem of low efficiency in manually cleaning the swimming pool can be resolved, and the cleaning efficiency of the swimming pool can be improved.

In a process in which the cleaning device cleans the wall, the cleaning device may move from a certain position at the bottom of the target water region to the wall, and then perform cleaning from the bottom of the wall to the water surface along the first cleaning path in the first direction. In this case, the cleaning device may move backward or turn around and then perform cleaning along the first cleaning path in the second direction, or the cleaning device may translate for a certain distance at the water surface and then perform cleaning in the second direction. The translation distance is less than a width of the cleaning device or an effective cleaning width of the cleaning device, such as a ¼ body, a ⅓ body, a ½ body, a ⅔ body, or a ¾ body. That the cleaning device performs cleaning in the second direction may be that the cleaning device performs cleaning until the cleaning device reaches the bottom of the wall and then is adjusted to perform cleaning in the first direction again until the cleaning device reaches, for example, a point Q in FIG. 9e, or the cleaning device may perform cleaning in the second direction until the cleaning device reaches a position at which there is a preset distance between the cleaning device and the water surface or the bottom of the target water region, for example, the point Q in FIG. 9 e, and then rotate at the point Q and move for a preset distance or preset duration to a starting position of a next cleaning path. In this case, the cleaning device rotates at the starting position and is adjusted to have a posture for performing cleaning along this cleaning path. In this posture, the cleaning device may move in the first direction to perform a cleaning task until the cleaning device reaches the water surface, or the cleaning device may move in the second direction to perform the cleaning task until the cleaning device reaches the bottom of the wall. Then, the cleaning device may repeat the above actions to complete cleaning the entire wall.

Certainly, the cleaning device may alternatively move from a position on the water surface and is adjusted from a water surface cleaning posture to a wall cleaning posture. In this case, the cleaning device performs cleaning along the first cleaning path in the wall cleaning posture from the water surface to the bottom of the wall in the second direction. Then, the cleaning device performs the cleaning task along the first cleaning path in the first direction, or the cleaning device performs the cleaning task in the first direction after translating for a preset distance relative to the first cleaning path. After the cleaning device reaches the water surface, the cleaning device is adjusted to perform the cleaning task in the second direction again until the cleaning device reaches the point Q, or the cleaning device may move in the first direction to the point Q at which there is a preset distance between the cleaning device and the water surface or the bottom of the target water region. The cleaning device rotates by a preset angle at the point Q and moves for preset duration or a preset distance to a starting position of a next cleaning path. Then, the cleaning device rotates again (for example, a rotation direction is opposite to a previous rotation direction, and a rotation angle is the same as a previous rotation angle, or the rotation direction is the same as the previous rotation direction, and the rotation angle is obtained by subtracting the previous rotation direction from 180°, or the rotation direction is opposite to the previous rotation direction, and the rotation angle is obtained by adding the previous rotation angle to 180°), and is adjusted to have a cleaning posture for performing cleaning along the next cleaning path. In this case, the cleaning device may perform the cleaning task along this cleaning path in the first direction until the cleaning device reaches the water surface, or the cleaning device may perform the cleaning task along this cleaning path in the second direction until the cleaning device reaches the bottom of the wall. Then, the cleaning process can be repeated.

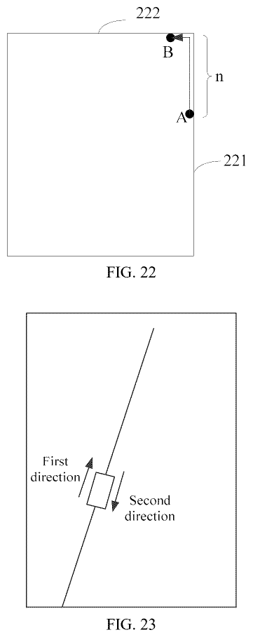

In one embodiment, before the cleaning device cleans the first wall of the target water region, the cleaning device is located at the bottom of the target water region, and the method further includes: determining a variation of a current yaw angle of the cleaning device at a current position point relative to a starting yaw angle of the cleaning device at the starting point at which the cleaning device moves along the edge of the target water region; and in a case where the variation is greater than a preset yaw angle, taking the current position point as a wall climbing point, and controlling the cleaning device to climb from the wall climbing point to the first wall to clean the first wall; or in a case where the variation is not greater than the preset yaw angle, controlling the cleaning device to continue to move along the edge to a position point at which the variation of the current yaw angle relative to the starting yaw angle is greater than the preset yaw angle. That the variation is greater than the preset yaw angle may be that an accumulated angle of the current yaw angle relative to the starting yaw angle is greater than or equal to a preset angle (for example, 360+45°), and the current position point is taken as the wall climbing point. In other words, it is determined that the cleaning device returns to the vicinity of the starting point at which the cleaning device moves along the edge, and moves by a certain angle (for example, 45°) more than an angle by which the cleaning device returns to the starting point at which the cleaning device moves along the edge, so that the wall climbing point corresponds to a wall adjacent to a wall corresponding to the starting point at which the cleaning device moves along the edge. In this way, the following problem can be avoided: in a case where the starting point at which the cleaning device moves along the edge is taken as the wall climbing point, the wall corresponding to the starting point at which the cleaning device moves along the edge may not be cleaned. This improves the cleaning coverage. FIG. 22 is a top view of an embodiment of a target water region according to this application. As shown in FIG. 22, a point A is the starting point at which the cleaning device moves along the edge. When the cleaning device moves along the edge to the point A, the cleaning device is controlled to continue to move along the edge to a position point at which the variation of the current yaw angle relative to the starting yaw angle is greater than the preset yaw angle, namely, a point B. A wall corresponding to the point A is denoted as a wall 221, and a wall corresponding to the point B is denoted as a wall 222. After climbing the wall from the point B, the cleaning device cleans the wall 222. After completing cleaning, the cleaning device may move to the wall 221 to perform cleaning. In this way, the following case can be avoided: in a case where the point A is taken as the wall climbing point for cleaning the wall 222, a part of the wall 221 may not be cleaned, for example, a part, of the wall 221, corresponding to n.

It may be understood that in a process of cleaning the first wall, if the cleaning device encounters an obstacle, such as a wall light, the cleaning device may move along the wall to the bottom of the target water region to change a cleaning path, or the cleaning device may avoid the obstacle on the first wall and then complete moving along the remaining cleaning path, or the cleaning device may change a cleaning path on the first wall.

In one embodiment, before the cleaning device cleans the first wall of the target water region, the cleaning device is located at the bottom of the target water region, and a point on a wall closest to the cleaning device is taken as the wall climbing point. This can reduce duration for which the cleaning device moves to the wall climbing point, and improve wall cleaning efficiency.

It should be noted that when there are more than one cleaning path on a same wall, the cleaning device may move along each cleaning path in a same manner, or move along some cleaning paths in a same manner and move along some cleaning paths in different manners, or move along each cleaning path in a different manner. Similarly, when the cleaning device switches cleaning paths, switching manners may be all the same, or may be partially the same and partially different, or may be all different.

In one embodiment, the method further includes: in a case where it is determined that the cleaning device completes cleaning the first wall, controlling the cleaning device to move to the second wall adjacent to the first wall, and after the cleaning device moves to the second wall, controlling the cleaning device to start to clean the second wall against a coincidence line of the first wall and the second wall. The cleaning device is controlled to perform cleaning against the coincidence line, so that coverage over corners of the wall can be improved, and missed regions to be cleaned can be reduced. The cleaning device is controlled to move from the first wall to the second wall in the following manner: controlling the cleaning device to move from the first wall to the bottom of the target water region, and after the cleaning device reaches the bottom of the target water region, controlling the cleaning device to move from the bottom of the target ware region to the second wall; or controlling the cleaning device to move from the first wall to the second wall via the coincidence line, that is, controlling the cleaning device to directly move between the two walls; or controlling the cleaning device to move from the first wall to the water surface of the target water region, and after the cleaning device reaches the water surface of the target water region, controlling the cleaning device to move from the water surface to the second wall. That the cleaning device reaches the water surface of the target water region may be that the cleaning device is partially exposed at the water surface or completely exposed at the water surface.

In one embodiment, in a case where the cleaning device completes cleaning all walls of the target water region, the cleaning device is controlled to move to a wall adjacent to a wall on which cleaning is completed, to prevent the wall on which cleaning is completed from not being cleaned. The wall on which cleaning is completed is the last wall cleaned by the cleaning device. As shown in FIG. 22, if the wall on which cleaning is completed is the wall 222, the cleaning device may be controlled to move to the wall 221 to prevent the wall 222 from not being cleaned due to positioning deviation of the cleaning device and other factors. The cleaning device is controlled to move to the wall adjacent to the wall on which cleaning is completed, so that a manner for cleaning the wall on which cleaning is completed is the same as a manner for cleaning other walls. This reduces a possibility of missed cleaning.

In one embodiment, when there is no apparent coincidence line between the first wall and the second wall (for example, a joint between the first wall and the second wall is circular), the cleaning device may be controlled to move from the first wall to the second wall in a manner in which the cleaning device moves from the first cleaning path to the second cleaning path. The cleaning device may be further controlled to move to the water surface of the target water region or the bottom of the target water region, and to move to the second wall after rotating by a certain angle on the water surface of the target water region or the bottom of the target water region, to prevent the cleaning device from moving at the joint between the first wall and the second wall. Because the joint may have certain curvature, the cleaning device may slip, affecting wall switching.

In one embodiment, when the cleaning device is controlled to turn to and move on the second wall after moving from the first wall to the bottom of the target water region, if the second wall does not exist in front of the cleaning device, the cleaning device is controlled to rotate back by a certain angle in a direction toward the first wall to move to a wall. In this way, the following case can be avoided: when tuning to the second wall, the cleaning device cannot move to the second wall due to an excessively large rotation angle, or other objects are mistakenly recognized as the second wall due to a detection abnormality.

In one embodiment, the method includes: when the cleaning device cleans a first wall of the target water region, controlling the cleaning device to perform cleaning along a first cleaning path; controlling the cleaning device to move along the first cleaning path for a first target preset distance in a first direction or a second direction to a path switching position, where the first direction is a direction from the bottom of the target water region to a water surface of the target water region, and the second direction is a direction from the water surface of the target water region to the bottom of the target water region; controlling the cleaning device to move from the path switching position along a third path for preset duration or a second target preset distance to a starting position of a second cleaning path; and controlling the cleaning device to move along the second cleaning path in the first direction or the second direction to perform cleaning along the second cleaning path. The third path is different from the first cleaning path. The second cleaning path is different from the first cleaning path and the third path. The second cleaning path is substantially parallel to the first cleaning path. The path switching position is a starting position at which the first cleaning path is switched to the second cleaning path. The path switching position is away from the bottom of the first wall and a waterline of the target water region.

The third path is a path for moving from the path switching position to the starting position of the second cleaning path.

In one embodiment, the controlling the cleaning device to perform cleaning along a first cleaning path includes: controlling the cleaning device to perform cleaning along the first cleaning path in the first direction from the bottom of the target water region or the bottom of the first wall; or controlling the cleaning device to perform cleaning along the first cleaning path in the second direction from the waterline of the target water region or the top of the first wall. In other words, when the first cleaning path is on the first wall, a starting position of the first cleaning path may be at one of the bottom of the target water region, the bottom of the first wall, the waterline of the target water region, and the top of the first wall. Similarly, the starting position of the second cleaning path may be also at one of the above positions. Starting positions of different cleaning paths may be the same or different.

In another embodiment, the controlling the cleaning device to perform cleaning along a first cleaning path includes: controlling the cleaning device to perform cleaning along the first cleaning path in the first direction or the second direction from a position away from the bottom of the first wall and the waterline of the target water region. In other words, the cleaning device may perform cleaning along the first cleaning path from any position between the bottom of the first wall and the waterline of the target water region.

In one embodiment, the controlling the cleaning device to move along the second cleaning path in the first direction or the second direction to perform cleaning along the second cleaning path includes: controlling the cleaning device to move from the starting position of the second cleaning path along the second cleaning path in the first direction or the second direction to perform cleaning along the second cleaning path. A direction in which the cleaning device moves from the starting position of the second cleaning path along the second cleaning path is the same as or opposite to a direction in which the cleaning device moves along the first cleaning path to the path switching position. In other words, the direction in which the cleaning device moves along the first cleaning path to the path switching position may be the same as or different from the direction in which the cleaning device moves from the starting position of the second cleaning path.

In one embodiment, the controlling the cleaning device to move along the first cleaning path for a first target preset distance in a first direction or a second direction to a path switching position includes: controlling the cleaning device to move from the bottom of the target water region or the bottom of the first wall in the first direction to the path switching position. The controlling the cleaning device to move from the starting position of the second cleaning path along the second cleaning path in the first direction or the second direction to perform cleaning along the second cleaning path includes: controlling the cleaning device to first move from the starting position of the second cleaning path along the second cleaning path in the first direction to perform cleaning, or to first move from the starting position of the second cleaning path along the second cleaning path in the second direction to perform cleaning. That the cleaning device first moves along the second cleaning path in the first direction or the second direction means that the cleaning device moves from the starting position of the second cleaning path, the 1^{st} moving direction may be the first direction or the second direction, and a next moving direction of the cleaning device may remain unchanged or may be changed.

In one embodiment, the controlling the cleaning device to move along the first cleaning path for a first target preset distance in a first direction or a second direction to a path switching position includes: controlling the cleaning device to move from the waterline of the target water region or the top of the first wall in the second direction to the path switching position. The controlling the cleaning device to move from the starting position of the second cleaning path along the second cleaning path in the first direction or the second direction to perform cleaning along the second cleaning path includes: controlling the cleaning device to first move from the starting position of the second cleaning path along the second cleaning path in the second direction to perform cleaning, or to first move from the starting position of the second cleaning path along the second cleaning path in the first direction to perform cleaning.

In one embodiment, before the cleaning device reaches the path switching position for path switching, the cleaning device traverses the first cleaning path at least once, or before the cleaning device reaches the path switching position for path switching, the cleaning device cleans the path switching position at least once. In other words, before the cleaning device moves from the first cleaning path to the second cleaning path, all positions on the first cleaning path are cleaned by the cleaning device at least once, or the path switching position is cleaned by the cleaning device at least once

In one embodiment, before the cleaning device moves from the bottom of the target water region or the bottom of the first wall in the first direction to the path switching position for path switching, the cleaning device completes moving from in the first direction to the second direction at the waterline of the target water region at least once.

In one embodiment, before the cleaning device moves from the waterline of the target water region or the top of the first wall in the second direction to the path switching position for path switching, the cleaning device completes moving from in the second direction to the first direction at the bottom of the target water region or the bottom of the first wall at least once.

In one embodiment, the controlling the cleaning device to move from the path switching position along a third path for preset duration or a second target preset distance to a starting position of a second cleaning path includes: controlling the cleaning device to adjust a moving direction and move to the starting position of the second cleaning path; or controlling the cleaning device to translate to the starting position of the second cleaning path. Controlling the cleaning device to adjust a moving direction may be that the cleaning device adjusts the moving direction during moving, or the cleaning device first adjusts the moving direction and then moves in an approximately straight-line direction.

In one embodiment, after the cleaning device moves to the starting position of the second cleaning path, the method further includes: adjusting a moving direction of the cleaning device, causing the cleaning device to perform cleaning along the second cleaning path in the first direction or the second direction. For example, after the cleaning device moves to the starting position of the second cleaning path, if the moving direction of the cleaning device deviates from the first direction or the second direction, the moving direction may be adjusted, so that the cleaning device can move in the first direction or the second direction. The moving direction may be adjusted through differential adjustment or in other manners.

In one embodiment, the first cleaning path at least partially overlaps with the second cleaning path. The first wall is used as an example. A coverage area of the housing of the cleaning device or an effective cleaning range of the cleaning member of the cleaning device when the cleaning device moves along the first cleaning path at least partially overlaps with a coverage area of the housing of the cleaning device or an effective cleaning range of the cleaning member of the cleaning device when the cleaning device moves along the second cleaning path. The effective cleaning range of the cleaning member may be a coverage area of the cleaning member or a radiating area in which the cleaning member can provide a cleaning effect.

In one embodiment, when moving in the first direction and the second direction, the cleaning device remains substantially the same posture, or the cleaning device moves backward in the second direction. For example, the cleaning device moves forward both in the first direction and the second direction, or the cleaning device moves forward in one of the first direction and the second direction and moves backward in the other one of the first direction and the second direction.

In one embodiment, when there is an obstacle on the first cleaning path, the cleaning device is controlled to perform an obstacle avoidance action.

In one embodiment, the obstacle avoidance action includes: when the cleaning device detects that there is an obstacle in a current moving direction, the cleaning device moves in a direction opposite to the current moving direction; or when the cleaning device detects that there is an obstacle on the first cleaning path, the cleaning device is switched to move along the second cleaning path.

In one embodiment, the method further includes: after the cleaning device is switched to move along the second cleaning path and performs cleaning for a preset distance, switching the cleaning device to move along the first cleaning path again to perform cleaning.

In one embodiment, the method further includes: controlling the cleaning device to move from the first wall to a second wall adjacent to the first wall; and after the cleaning device moves to the second wall, controlling the cleaning device to clean the second wall against a coincidence line of the first wall and the second wall at least once. The cleaning device may start to clean the second wall against the coincidence line of the first wall and the second wall, or may return to the coincidence line of the first wall and the second wall and perform cleaning during or after a process of cleaning the second wall. That the cleaning device cleans the second wall against the coincidence line of the first wall and the second wall may be that the cleaning device moves along the coincidence line of the first wall and the second wall and cleans the coincidence line and a region near the coincidence line, or the cleaning device performs reciprocating motion on a left side and a right side of the coincidence line and cleans the coincidence line and a region near the coincidence line.

In one embodiment, the controlling the cleaning device to move from the first wall to a second wall adjacent to the first wall includes: controlling the cleaning device to move from the first wall to the bottom of the target water region, and after the cleaning device reaches the bottom of the target water region, controlling the cleaning device to move from the bottom of the target water region to the second wall; or controlling the cleaning device to move from the first wall to the second wall via the coincidence line; or controlling the cleaning device to move from the first wall to the water surface of the target water region, and after the cleaning device reaches the water surface of the target water region, controlling the cleaning device to move from the water surface to the second wall.

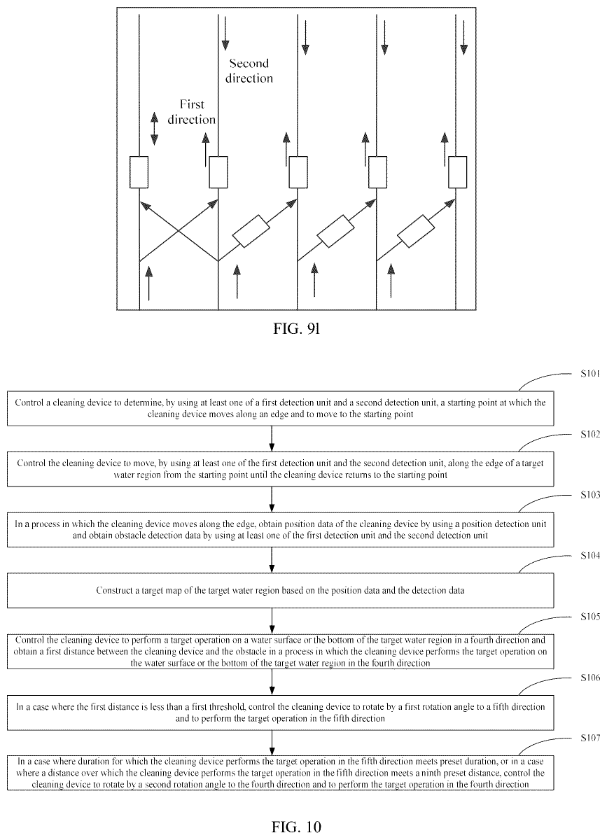

Refer to FIG. 10 and FIG. 11. FIG. 10 is a schematic flowchart of a fifth embodiment of a cleaning device control method according to this application. FIG. 11 is a schematic diagram of a water surface cleaning trajectory of a target water region according to an embodiment of this application. The method includes the following steps.

S101: Control a cleaning device to determine, by using at least one of a first detection unit and a second detection unit, a starting point at which the cleaning device moves along an edge and to move to the starting point.

S102: Control the cleaning device to move, by using at least one of the first detection unit and the second detection unit, along the edge of a target water region from the starting point until the cleaning device returns to the starting point.

S103: In a process in which the cleaning device moves along the edge, obtain position data of the cleaning device by using a position detection unit and obtain obstacle detection data by using at least one of the first detection unit and the second detection unit.

S104: Construct a target map of the target water region based on the position data and the detection data.

For specific implementation of steps S101 to S104, refer to related descriptions of the first embodiment of the cleaning device control method provided in this application. Details are not described herein again.

S105: Control the cleaning device to perform a target operation on a water surface or the bottom of the target water region in a fourth direction and obtain a first distance between the cleaning device and the obstacle in a process in which the cleaning device performs the target operation on the water surface or the bottom of the target water region in the fourth direction.

In one embodiment, the first distance is a distance between a front portion of the cleaning device and the obstacle, and the target water region includes, but is not limited to, a swimming pool, an ornamental reservoir, a wild pool, and the like. The cleaning device may move on the water surface or the bottom of the target water region in the fourth direction based on a preset trajectory. The preset trajectory includes at least one of an S-shaped trajectory, an N-shaped trajectory, a bow-shaped trajectory, a square spiral trajectory, or a straight trajectory. The target operation may include, but is not limited to, cleaning, disinfection, and the like. In this embodiment, the target operation is performed after the target map is constructed. In some embodiments, construction of the target map and the target operation may alternatively be performed simultaneously, that is, in a process of controlling the cleaning device to move along the edge of the target water region, the map is constructed, and the target operation is also performed. In some embodiments, construction of the target map and the target operation may alternatively be performed independently, that is, the target operation may be performed independently, and construction of the target map may be also performed independently.

The obstacle includes at least one of a physical obstacle and a virtual obstacle. The virtual obstacle may be a boundary of divisions of the water region, a virtual wall, or the like. The physical obstacle may include a wall of the target water region.

In one embodiment, the method further includes: obtaining a current moving direction of the cleaning device in real time in the process in which the cleaning device performs the target operation on the water surface or the bottom of the target water region in the fourth direction; in a case where the current moving direction deviates from the fourth direction, adjusting a moving angular velocity and/or a moving linear velocity of the cleaning device; and correcting the current moving direction based on the adjusted moving angular velocity and/or the adjusted moving linear velocity to control the cleaning device to perform the target operation in the fourth direction. In the above embodiment, the moving angular velocity may be 1 rad/s or 1.5 rad/s. Certainly, the above value is only an example. The actual moving angular velocity may be any appropriate angular velocity determined based on an adjustment requirement of the cleaning device. According to the above embodiment, in a case where it is determined that the current moving direction of the cleaning device deviates, the angular velocity is adjusted in time to correct the current moving direction of the cleaning device. This can effectively improve stability of an operation route of the cleaning device.

In one embodiment, before the obtaining a current moving direction of the cleaning device in real time in the process in which the cleaning device performs the target operation on the water surface or the bottom of the target water region in the fourth direction, the method further includes: in a case where an angular deviation between the current moving direction and the fourth direction is greater than or equal to a second threshold, determining that the current moving direction deviates from the fourth direction. In the above embodiment, the second threshold may be 20°, 30°, or 25°. Certainly, the above value is only an example. The second threshold may be any appropriate angle value that allows a deviation in the moving direction of the cleaning device. Whether the current moving direction of the cleaning device deviates is determined accurately and easily based on a preset threshold. This improves operating efficiency of the cleaning device.

S106: In a case where the first distance is less than a first threshold, control the cleaning device to rotate by a first rotation angle to a fifth direction and to perform the target operation in the fifth direction.

In one embodiment, the first threshold may be any length within a range from 20 cm to 30 cm, and the length may be determined based on a width of a housing of the cleaning device, a braking distance, an operation width of the cleaning device, or the like. For example, the first threshold is slightly less than the operation width of the cleaning device, and the operation width of the cleaning device may range from 30 cm to 35 cm. The operation width of the cleaning device may be an effective cleaning width of the cleaning device or the width of the housing of the cleaning device. The effective cleaning width may be a length of the cleaning device, a width of a cleaning range of the cleaning member, or the like. The cleaning member may be a roller brush, a debris inlet, or the like. This can increase an actual operation coverage area of the cleaning device in the target water region and increase coverage of an actual operation range of the cleaning device over the target water region. That the first distance is less than the first threshold may indicate that the cleaning device collides with an obstacle or is about to collide with an obstacle.

In one embodiment, determining the first rotation angle of the cleaning device in a case where the first distance is less than the first threshold includes: determining a first preset angle as the first rotation angle in a case where a pointing direction of the current moving direction is a first pointing direction, and determining a second preset angle as the first rotation angle in a case where the pointing direction of the current moving direction is a second pointing direction. The fourth direction includes the first pointing direction and the second pointing direction. The first pointing direction is opposite to the second pointing direction. The first preset angle and the second preset angle correspond to opposite directions. In the above embodiment, the first pointing direction and the second pointing direction are opposite to each other. FIG. 21 is a schematic diagram of an embodiment of a motion path of a cleaning device according to this application. As shown in FIG. 21, an example in which the target water region is a rectangular swimming pool, and a longest side of the swimming pool runs south-north is used. In this case, the first pointing direction may be a direction from west to east, and the second pointing direction may be a direction from east to west. Further, in a case where a coverage direction in which the cleaning device cleans the water surface or the bottom of the target water region is from south to north, if the cleaning device moves in a direction from west to east, the first rotation angle is 90° counterclockwise (in a top view of the swimming pool), that is, the cleaning device rotates toward the north by 90°; and if the cleaning device moves in a direction from east to west, the first rotation angle is 90° clockwise, that is, the cleaning device rotates toward the north by 90°. According to the above embodiment, a next steering angle is determined based on a moving direction of the cleaning device. This can effectively reduce difficulty of handling a complex water region and improve cleaning efficiency.

The fourth direction and the fifth direction form an included angle greater than 0° and less than 180°. The included angle between the fourth direction and the fifth direction may be a preset fixed angle. For example, the fourth direction is perpendicular to the fifth direction. The included angle between the fourth direction and the fifth direction may alternatively be determined based on the target map, for example, a shape of the target water region in the target map. For example, in a case where the target water region is a rectangular swimming pool, the fourth direction may be approximately a direction of the longest side of the rectangular swimming pool and include two directions along the longest side, and the fifth direction may be approximately a direction of a shortest side of the rectangular swimming pool. A corner of the rectangular swimming pool may be taken as a motion starting point of the cleaning device.

In one embodiment, after the cleaning device is controlled to move in the target water region along a boundary of the target water region by one round, a moving direction in which moving duration exceeds a preset threshold is determined as the fourth direction, and a direction perpendicular to the fourth direction or toward another angle is determined as the fifth direction.

S107: In a case where duration for which the cleaning device performs the target operation in the fifth direction meets preset duration, or in a case where a distance over which the cleaning device performs the target operation in the fifth direction meets a ninth preset distance, control the cleaning device to rotate by a second rotation angle to the fourth direction and to perform the target operation in the fourth direction.

That a moving direction in which moving duration exceeds a preset threshold is determined as the fourth direction means that a direction in which the cleaning device moves straight along the wall for the longest time in a process of moving along an edge of the water surface or the bottom of the target water region is determined as the fourth direction. There may be one or a plurality of moving directions in which moving duration exceeds the preset threshold. In a case where there are a plurality of moving directions in which moving duration exceeds the preset threshold, a moving direction may be randomly selected as the fourth direction. For example, in a case where the target water region is a rectangular swimming pool, a direction in which the cleaning device moves straight for the longest time in a process of moving along an edge of the swimming pool by one round is a direction of a longest side. For example, in a case where the target water region is a circular pool, there are a plurality of straight moving directions in which moving duration is the same in a process of moving along an edge of the swimming pool by one round. In this case, a moving direction may be randomly selected as the fourth direction.

In one embodiment, the cleaning device may move in the target water region along the cleaning path, for example, the bow-shaped trajectory or the S-shaped trajectory. In a process in which the cleaning device moves in the target water region substantially along the bow-shaped trajectory, a direction of the first rotation angle is consistent with that of the second rotation angle, for example, 90° clockwise or 90° counterclockwise. The preset duration may be 2 s, 3 s, or 2.5 s. The preset duration is related to a speed at which the cleaning device moves in the target water region. A distance over which the cleaning device moves in the fifth direction within the preset duration is slightly less than the operation width of the cleaning device. Specifically, the distance may be ½ to ⅓ of the operation width of the cleaning device, or less than the operation width of the cleaning device but greater than ½ of the operation width of the cleaning device. The distance is set to be less than the operation width of the cleaning device, so that a part between two adjacent cleaning paths can be covered by the operation width of the cleaning device, thereby ensuring the cleaning coverage. In addition, the distance is set to be greater than ½ of the operation width of the cleaning device, so that the cleaning device can be prevented from performing repeated cleaning during performing cleaning along the two adjacent cleaning paths. Therefore, a moving distance of the cleaning device in the fifth direction is appropriately set, so that the cleaning coverage can be ensured, and unnecessary repeated cleaning can be avoided, thereby improving the cleaning efficiency.

Optionally, in a case where the cleaning device collides with the obstacle, the cleaning device is controlled to rotate by the first rotation angle to perform the target operation in the fifth direction. Optionally, in a case where the distance over which the cleaning device performs the target operation in the fifth direction meets a preset distance, the second rotation angle of the cleaning device is determined, and the cleaning device is controlled to rotate by the second rotation angle to perform the target operation in the fourth direction.

The rotation angle and the moving direction of the cleaning device are continuously adjusted based on a distance between the cleaning device and the obstacle, so that the cleaning device can move in a planned manner. This can prevent the cleaning device from randomly selecting a moving direction in a case where the cleaning device collides with the obstacle.

In one embodiment, the second rotation angle of the cleaning device may be determined in the following manner: determining a first rotation direction of the first rotation angle, and determining the second rotation angle based on the first rotation direction and the first rotation angle. In the above embodiment, if the fourth direction includes the direction of the longest side of the rectangular swimming pool, and the fifth direction includes the direction of the shortest side of the rectangular swimming pool, the first rotation direction may include a direction in which the cleaning device rotates from the longest side to the shortest side, the first rotation angle may include an angle by which the cleaning device rotates from the longest side to the shortest side, and the second rotation angle may include an angle by which the cleaning device rotates from the shortest side to the longest side. For example, the bow-shaped path of the cleaning device includes a plurality of shorter sides (namely, paths approximately parallel to the longest side) and a plurality of longer sides (namely, paths approximately parallel to the shortest side). When the cleaning device moves in the direction of the shortest side of the rectangular swimming pool, a shorter side on which the cleaning device currently moves is connected to a previous longer side and a next longer side. The previous longer side is a longer side on which the cleaning device has already moved, and the next longer side is a longer side on which the cleaning device is about to move. For details of a rotation direction in which the cleaning device rotates from the current shorter side to the next longer edge, refer to descriptions of a rotation direction in which the cleaning device rotates from the previous longer side to the current shorter side. Two rotation directions are consistent According to the above embodiment, the second rotation angle by which the cleaning device rotates from the fifth direction to the fourth direction can be quickly determined. This improves the operation efficiency of the cleaning device.

As shown in FIG. 21, in a rectangular swimming pool whose longest side runs from south to north, the cleaning device performs cleaning from south to north. In this case, the shorter sides of the bow-shaped path of the cleaning device may be grouped into east shorter sides and west shorter sides. When the cleaning device moves from a longer side to an east shorter side, the cleaning device needs to rotate counterclockwise by 90°. When the cleaning device moves from a longer side to a west shorter side, the cleaning device needs to rotate clockwise by 90°. Similarly, when the cleaning device moves from an east shorter side to a longer side, the cleaning device needs to rotate counterclockwise by 90°, and when the cleaning device moves from a west shorter side to a longer side, the cleaning device needs to rotate clockwise by 90°. In other words, a rotation direction in which the cleaning device rotates from a shorter side to a longer side is consistent with a rotation direction in which the cleaning device rotates from a previous longer side to the current shorter side.

In one embodiment, after the controlling the cleaning device to rotate by a first rotation angle to a fifth direction and to perform the target operation in the fifth direction in a case where the first distance is less than a first threshold, the method further includes: obtaining a second distance between the cleaning device and the obstacle, and in a case where the second distance is less than a third threshold, controlling the cleaning device to stop moving to stop performing the target operation. In the above embodiment, the second distance is a distance between the front portion of the cleaning device and the obstacle, and the third threshold may be an appropriate value less than the operation width of the cleaning device. In the above embodiment, an appropriate occasion on which the cleaning device ends a cleaning process is determined by setting the third threshold, thereby effectively improving overall cleaning efficiency.

In one embodiment, before the obtaining a first distance between the cleaning device and the obstacle in a process in which the cleaning device performs the target operation on the water surface or the bottom of the target water region in the fourth direction, the cleaning device is controlled to perform at least one of the following in the target water region: performing the target operation on the water surface or the bottom of the target water region along the boundary of the target water region; moving on the water surface or the bottom of the target water region along the boundary of the target water region; and constructing the map of the target water region after moving in the target water region along the boundary of the target water region. According to the above embodiment, the cleaning device moves along the edge first and then cleans the target water region, so that the cleaning device can effectively adapt to different target water regions. This reduces complexity of performing full-coverage cleaning on a water region.

In one embodiment, a process of cleaning a water surface of the rectangular swimming pool is used as an example. After entering the rectangular swimming pool, the cleaning device may first perform full-coverage cleaning on the water surface and then perform cleaning along an edge of the rectangular swimming pool. A process in which the cleaning device performs full-coverage cleaning on the water surface includes the following steps. The cleaning device moves to the corner of the rectangular swimming pool and rotates to the direction of the longest side (namely, the fourth direction), where the direction of the longest side and the corner of the rectangular swimming pool may be determined based on the map of the rectangular swimming pool. The cleaning device moves from the corner of the rectangular swimming pool in the direction of the longest side and cleans the water surface of the swimming pool on the way. The cleaning device detects a distance between the cleaning device and a wall in front of the cleaning device in a process of moving in the direction of the longest side. In a case where the cleaning device detects that the distance between the cleaning device and the wall in front of the cleaning device is less than the first threshold, the cleaning device rotates by a first azimuth (namely, the first rotation angle) to the direction of the shortest side (namely, the fifth direction), where the first azimuth is an angle by which the cleaning device needs to rotate to the direction of the shortest side. The cleaning device may move in the direction of the shortest side for preset duration or for a preset distance. The cleaning device detects a distance between the cleaning device and a wall of the swimming pool in front of the cleaning device in a process of moving in the direction of the shortest side. In a case where the distance is less than a fourth threshold, the cleaning device ends the process of performing full-coverage cleaning on the water surface, or in a case where the distance is greater than the fourth threshold, the cleaning device is controlled to move to the corner of the rectangular swimming pool and rotate by a second azimuth (namely, the second rotation angle) to the direction of the longest side, and the above process is repeated, where the second azimuth is an angle by which the cleaning device needs to rotate to the direction of the longest side. The cleaning device ends the process of performing full-coverage cleaning on the water surface. A process of cleaning the bottom of the rectangular swimming pool is similar to the above process, and details are not described herein again.

In one embodiment, before the controlling the cleaning device to perform a target operation on a water surface or the bottom of the target water region in a fourth direction, the method further includes: in a case where an initial position at which the cleaning device reaches the water surface or the bottom of the target water region is not at the edge of the target water region, controlling the cleaning device to move to the edge of the target water region, where that the initial position is not at the edge of the target water region indicates that a distance between the initial position and the wall is greater than a tenth preset distance; and after the cleaning device reaches the edge, controlling the cleaning device to move from the edge in the fourth direction based on a preset trajectory to perform the target operation.

In one embodiment, when the cleaning device performs planned cleaning on the water surface, an external force (for example, wind) applied to the cleaning device on the water surface may cause a positioning error of the cleaning device. Consequently, there is a distance between a planned motion ending position and a position at which the cleaning device completes moving along the cleaning path, leading to severely missed cleaning. As a result, a cleaning effect is affected. To resolve this problem, the water surface may be divided into different regions, and polling cleaning is performed on the water surface in order from the edge to the middle, thereby reducing an impact caused by the external force. As shown in FIG. 11, the water surface may be divided into four regions. A region 1 and a region 2 are edge regions of the water surface, and a region 3 and a region 4 are middle regions of the water surface. The cleaning device may clean the water surface in order of the region 1, the region 2, the region 3, and the region 4. A position at which the cleaning device reaches the region 1 is a starting point for water surface cleaning. The cleaning device cleans the region 1 from the starting point based on a preset trajectory. After completing cleaning the region 1, the cleaning device moves to the region 2 along the edge of the target water region to clean the region 2. A position at which the cleaning device completes cleaning the region 1 may or may not be at the edge of the target water region. If the position is not at the edge of the target water region, the cleaning device may be controlled to move to a closest edge of the target water region and then move to the region 2 along the edge. Similarly, after cleaning of the region 2 is completed, the cleaning device is controlled to move to the region 3 along the edge. In one specific embodiment, the cleaning device may move from the region 2 to the region 3 along a switching path shown in FIG. 11. An advantage of moving between different regions along the edge is that the edge of the water surface can be cleaned repeatedly, preventing garbage from drifting to the edge of the water surface due to swaying of the water surface or the external force in a moving process of the cleaning device. The cleaning device repeatedly moves along the edge, so that garbage can be effectively prevented from being missed, thereby further improving the cleaning effect. It may be understood that the present embodiment is only an example. In other embodiments, the water surface may be divided into regions in any manner based on a shape, a size, and other factors of the target water region, and the cleaning device may move between various regions of the water surface along any switching path, provided that it is ensured that the water surface is completely cleaned by the cleaning device. For example, a region division manner for the water surface and a switching path between various regions may be determined based on the shape, the size, and other factors of the target water region. After water surface cleaning is completed, the cleaning device may be controlled to return to the starting point for water surface cleaning. Specifically, whether the cleaning device returns to the starting point for water surface cleaning may be determined based on a position and/or a posture of the cleaning device. If the cleaning device returns to the starting point for water surface cleaning, the front portion of the cleaning device may be controlled to face a wall of the target water region, and a moving member of the cleaning device is turned on, for example, a target propeller, so that the cleaning device can remain to be close to the edge.

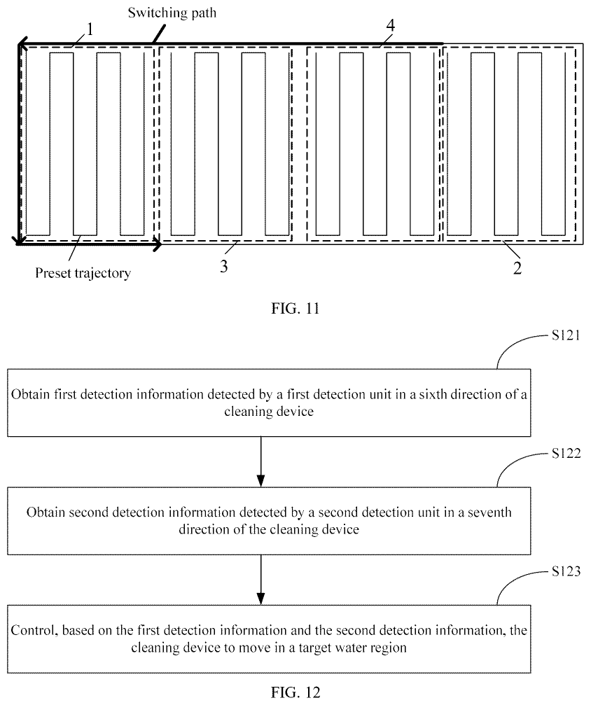

Refer to FIG. 12. FIG. 12 is a schematic flowchart of a sixth embodiment of a cleaning device control method according to this application. The method includes the following steps.

S121: Obtain first detection information detected by a first detection unit in a sixth direction of a cleaning device.

S122: Obtain second detection information detected by a second detection unit in a seventh direction of the cleaning device.

S123: Control, based on the first detection information and the second detection information, the cleaning device to move in a target water region.

In this embodiment, a moving direction of the cleaning device in the target water region may be determined. Motion of the cleaning device may be controlled based on the moving direction in a map construction process or in a cleaning process. The first detection information and the second detection information may be further used in the map construction process and may be fused with data obtained by using an inertial measurement unit (IMU), a code disk, a depth sensor, and the like of the cleaning device, to position the cleaning device in real time. In one embodiment, a cleaning member may be disposed on a front portion of the cleaning device and may filter water in the target water region to clean the water in the target water region. The cleaning member may alternatively be disposed on a side portion (for example, a right side portion) of the cleaning device, and a wall of the target water region is cleaned by using the cleaning member. A cleaning manner of the cleaning device may be that a pumping member draws liquid through a water inlet, debris and garbage in the liquid are filtered by a filter, and the filtered water is discharged through a water outlet. In this way, the liquid in the target water region is cleaned.

In one embodiment, each of the first detection unit and the second detection unit may be a sensor capable of measuring a distance, for example, an ultrasonic sensor, an infrared sensor, or a TOF (Time of Flight) sensor. The sixth direction is a forward direction of the cleaning device, and the seventh direction may be to the left or right relative to the cleaning device. An example in which the seventh direction is to the right relative to the cleaning device is used. The second detection unit is disposed on the right side portion of the cleaning device and configured to detect information to the right of the cleaning device (namely, the seventh direction).

The first detection information may indicate a distance between the cleaning device and a first obstacle in the sixth direction. The second detection information may indicate a distance between the cleaning device and a second obstacle in the seventh direction. Each of the first obstacle and the second obstacle may be a wall. The sixth direction may be a forward direction of the cleaning device. An included angle between the sixth direction and the seventh direction may be a preset angle. The preset angle may range from 0°to 180°and may be set as required. This is not specifically limited herein.

In one embodiment, the controlling the cleaning device to move in a target water region includes at least one of the following: in a case where the first detection information indicates the distance between the cleaning device and the first obstacle in the sixth direction, and the distance is less than an eleventh preset distance, controlling the cleaning device to move toward an eighth direction away from the seventh direction, where the first obstacle may be a wall in front of the cleaning device, and the eighth direction is opposite to the seventh direction; and in a case where the second detection information indicates the distance between the cleaning device and second obstacle in the seventh direction, and the distance is greater than a second preset value, controlling the cleaning device to deviate toward a preset direction to reduce the distance between the cleaning device and second obstacle in the seventh direction. The second obstacle may be a wall on a side of the cleaning device. The preset direction includes at least one of the seventh direction and a direction parallel to the second obstacle.

In the above solution, in a case where the seventh direction is to the right relative to the cleaning device, the eighth direction is to the left relative to the cleaning device. The cleaning member may be disposed on the right side portion or a left side portion of the cleaning device, and a wall of the target water region is cleaned by using the cleaning member in a moving process of the cleaning device.

The eleventh preset distance may be set based on an actual situation or based on a detection range (a blind zone) of the ultrasonic sensor, for example, may be one meter. When the first detection unit detects that the distance between the obstacle in front of the cleaning device and the cleaning device reaches the eleventh preset distance, it indicates that the front portion of the cleaning device is close to the wall of the target water region. In this case, the cleaning device needs to be controlled to perform steering to avoid a collision.

Specifically, to enable the cleaning device to clean corners of the target water region more thoroughly, a twelfth preset distance may be set. The twelfth preset distance is less than the eleventh preset distance. The controlling the cleaning device to move toward an eighth direction may include: when the distance between the cleaning device and the first obstacle in the sixth direction is less than or equal to the eleventh preset distance, first controlling the cleaning device to decelerate, and then when the distance between the cleaning device and the first obstacle is equal to the twelfth preset distance, controlling the cleaning device to rotate to the eighth direction, or controlling the cleaning device to move backward for a certain distance in a direction opposite to the sixth direction, and then controlling the cleaning device to rotate to the eighth direction; or when the distance between the cleaning device and the first obstacle in the sixth direction is less than or equal to the eleventh preset distance, simultaneously controlling the cleaning device to decelerate and rotate toward the eighth direction, so that when the second detection unit of the cleaning device detects obstacle information, the cleaning device stops rotating.

In one embodiment, an example in which the seventh direction is to the right of the cleaning device is used. When the cleaning device is far away from a wall on the right side, the cleaning device is controlled to be close to the wall on the right side and then move in a direction approximately parallel to the wall on the right side, to ensure that the cleaning device performs cleaning more thoroughly along the edge. When the cleaning device is close to the wall on the right side, the cleaning device is controlled to be away from the wall on the right side and then move in the direction approximately parallel to the wall on the right side, to ensure that the cleaning device can normally clean the wall and the edge of the target water region. Specifically, a second preset value and a third preset value may be set, and the third preset value is less than the second preset value. When the distance between the cleaning device and the wall on the side of the cleaning device in the seventh direction is greater than the second preset value, the cleaning device is controlled to deviate toward the seventh direction. When the distance between the cleaning device and the wall on the side of the cleaning device in the seventh direction is equal to the third preset value, the cleaning device is controlled to move in the direction approximately parallel to the wall on the side of the cleaning device. A fourth preset value may be further set. The fourth preset value is less than the third preset value. When the distance between the cleaning device and the wall on the side of the cleaning device in the seventh direction is less than the third preset value and greater than or equal to the fourth preset value, the cleaning device is controlled to remain at an original speed or decelerate and rotate at a preset rotation speed toward the eighth direction, or the cleaning device is controlled to move in a direction away from the wall on the side of the cleaning device until the distance between the cleaning device and the wall on the side of the cleaning device reaches the third preset value, and then the cleaning device is controlled to move in the direction approximately parallel to the wall on the side of the cleaning device. The eighth direction is opposite to the seventh direction.

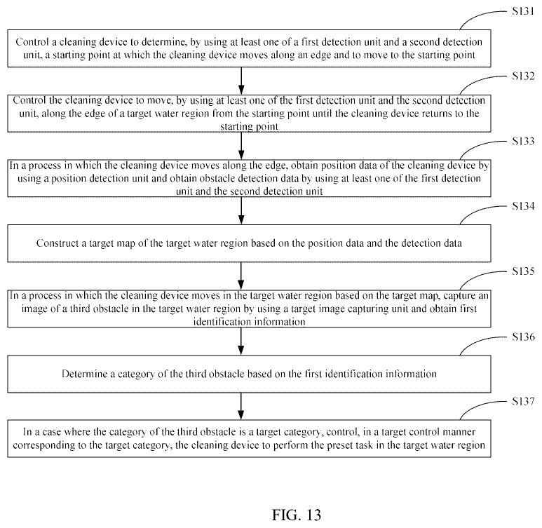

Refer to FIG. 13. FIG. 13 is a schematic flowchart of a seventh embodiment of a cleaning device control method according to this application. The method includes the following steps.

S131: Control a cleaning device to determine, by using at least one of a first detection unit and a second detection unit, a starting point at which the cleaning device moves along an edge and to move to the starting point.

S132: Control the cleaning device to move, by using at least one of the first detection unit and the second detection unit, along the edge of a target water region from the starting point until the cleaning device returns to the starting point.

S133: In a process in which the cleaning device moves along the edge, obtain position data of the cleaning device by using a position detection unit and obtain obstacle detection data by using at least one of the first detection unit and the second detection unit.

S134: Construct a target map of the target water region based on the position data and the detection data.

For specific implementation of steps S131 to S134, refer to related descriptions of the first embodiment of the cleaning device control method provided in this application. Details are not described herein again.

S135: In a process in which the cleaning device moves in the target water region based on the target map, capture an image of a third obstacle in the target water region by using a target image capturing unit and obtain first identification information.

In one embodiment, the first identification information indicates feature information obtained by performing image identification on the third obstacle. The feature information may be extracted based on an underwater target identification algorithm. The underwater target identification algorithm may be, but is not limited to, implemented based on artificial intelligence. The third obstacle may be understood as an obstacle that may be detected by the cleaning device in the target water region and is an obstacle different from a first obstacle or a second obstacle, for example, an obstacle such as a ladder, a rag, a leaf, or clothing that affects operation of the cleaning device. According to the cleaning device control method, a category of the obstacle is determined, and an appropriate control manner is selected based on the determined category of the obstacle to clean a water environment. The target image capturing unit may include any device capable of capturing an image such as a camera. The target image capturing unit may be disposed on a body of the cleaning device or outside the body of the cleaning device (for example, on a wall of the target water region or on a station), and communicate with the cleaning device in a wired or wireless manner.

In one embodiment, the capturing an image of a third obstacle in the target water region by using a target image capturing unit and obtaining first identification information includes: detecting the target water region by using a target sensor, and in a case where it is detected that there is the third obstacle in the target water region, capturing the image of the third obstacle in the target water region by using the target image capturing unit and obtaining the first identification information.

An occasion for detecting the target water region by using the target sensor may be any moment after the cleaning device enters the target water region, or any moment at which the cleaning device performs a task in the target water region. The image of the third obstacle in the target water region is captured by using the target image capturing unit to obtain target image data. The target image data is identified to determine the first identification information.

The target sensor may be the first detection unit and/or the second detection unit, or may be another detection device. The target sensor may be, but is not limited to, an ultrasonic sensor. Sensing information collected by the target sensor includes distance information and angle information. The distance information may include information of a distance between an obstacle detected by the target sensor and the cleaning device. The angle information may include information of an angle between the obstacle detected by the target sensor and the cleaning device.

In the process in which the cleaning device moves along the edge of the target water region, in a rotation process of the cleaning device, or in a process in which the cleaning device moves straight, a line segment data feature and an angle feature of the obstacle may be obtained based on the sensing information collected by the target sensor. The line segment data feature and the angle feature constitute some features of the target water region, for example, a corner and a wall of the target water region.

In one embodiment, the sensing information is collected by using the target sensor, for example, an ultrasonic sensor. The sensing information may include some features of the target water region, for example, an outer right angle, an inner right angle, an outer circular arc, and an inner circular arc of the target water region, and steps and a ladder in the target water region. Information of a distance between the cleaning device and a wall and information of a distance between the cleaning device and each corner of the target water region may be further detected by using the target sensor.

In one embodiment, the capturing an image of a third obstacle in the target water region by using a target image capturing unit and obtaining first identification information includes: capturing an image of the target water region by using the target image capturing unit, and in a case where it is detected that there is the third obstacle in the target water region, obtaining the first identification information.

In other words, the image of the target water region is captured by the target image capturing unit to obtain image data of the target water region, and the image data of the target water region is identified to determine whether there is the third obstacle in the target water region. If there is the third obstacle in the target water region, the target image data of the identified third obstacle is identified to obtain the first identification information. Determining whether there is the third obstacle in the target water region and obtaining the first identification information are implemented by using the target image capturing unit. An occasion for detecting the image of the target water region by using the target image capturing unit may be any moment after the cleaning device enters the target water region, or any moment at which the cleaning device performs a task in the target water region.

S136: Determine a category of the third obstacle based on the first identification information.

Different categories are preset for obstacles that may be detected in the target water region. The obstacles may be categorized based on impacts caused by the obstacles on operation of the cleaning device. When the cleaning device detects the obstacles of different categories, same or different control manners may be adopted to control the cleaning device.

In one embodiment, different categories may be preset for the obstacles that may be detected in the target water region, and an identification model may be trained based on feature information of the obstacles of these categories to obtain an identification algorithm for identifying and categorizing the obstacles. Further, the category of the third obstacle may be determined based on the identification algorithm and the first identification information.

It should be noted that the different categories set for the obstacles may be set manually based on prior knowledge or may be automatically generated based on a self-learning category generation algorithm.

For example, an obstacle such as clothing or a rag may adhere to a moving member of the cleaning device and affect normal motion of the cleaning device. In this case, it may be considered that the clothing, the rag, and other textiles are classified into one category.

For another example, an obstacle such as a ladder or a stone pillar may prevent the cleaning device from moving and affect normal motion of the cleaning device. In this case, it may be considered that the ladder, the stone pillar, and the like are classified into one category.

In one example embodiment, an example in which a category of an obstacle is a textile category is used. When the cleaning device detects that there is an object A in front, an image of the object A is captured by using the target image capturing unit, to obtain image data, and then feature extraction and a target detection operation are performed on the image data, to determine that the object A belongs to the textile category.

It should be noted that, when for the obstacles of different categories, different control manners are adopted to control the cleaning device, different cleaning strategies are adopted for the obstacles of different categories. For example, if a category of an obstacle is the textile category, a longer avoidance distance is set for the cleaning device compared with avoidance distances for obstacles of other categories, to prevent the cleaning device from being entangled by the obstacle of this category. For another example, if an obstacle is a ladder, a shorter avoidance distance is set for the cleaning device compared with avoidance distances for obstacles of other categories, to prevent the ladder from not being cleaned for a long time.

S137: In a case where the category of the third obstacle is a target category, control, in a target control manner corresponding to the target category, the cleaning device to perform a preset task in the target water region.

In one embodiment, the target control manner has a mapping relationship with the target category. The preset task may include, but is not limited to, one or a combination of performing cleaning, performing disinfection, performing water quality testing, and the like in the target water region.

In the above embodiment, categories of obstacles are identified, and the obstacles are processed based on the different categories. It is aimed at addressing a situation in which when the cleaning device encounters different obstacles during actual operation, an execution component of the cleaning device is blocked or a to-be-cleaned region is missed because the cleaning device cannot adopt an effective processing manner. This can improve operating efficiency of the cleaning device. Therefore, a problem of low operating efficiency of the cleaning device can be resolved.

In one optional solution, the method further includes: in a case where the cleaning device starts to perform the preset task, detecting a water depth at which the cleaning device is located; and determining a capturing parameter of the target image capturing unit based on the water depth and capturing the image of the third obstacle based on the capturing parameter to obtain the target image data. The cleaning device may be pre-configured with target image capturing units operating at different water depths. The target image capturing units operating at different water depths have different energy consumption and/or computing capabilities.

It should be noted that an instrument for detecting the water depth may be a conventional physical instrument. After the water depth at which the cleaning device is located is determined, a start-up instruction is sent to a target image capturing unit corresponding to the water depth, and then the corresponding target image capturing unit starts to operate.

In one embodiment, the determining a capturing parameter of the target image capturing unit based on the water depth and capturing the image of the third obstacle based on the capturing parameter to obtain the target image data includes: in a case where the cleaning device is at a first water depth, determining a first target image capturing unit; and in a case where the cleaning device is at a second water depth, determining a second target image capturing unit. The first target image capturing unit is configured to detect an obstacle at the first water depth. The second target image capturing unit is configured to detect an obstacle at the second water depth. The second water depth is greater than the first water depth. Power consumption of the second target image capturing unit is higher than power consumption of the first target image capturing unit.

Optionally, in this embodiment, the second water depth may be greater than the first water depth. In other words, when the cleaning device is at different water depths, different target image capturing units are used. When the cleaning device is at a large water depth, a workload of a target image capturing unit is heavier, and power consumption is high. When the cleaning device is at a small water depth, a workload of a target image capturing unit is lighter, and power consumption is low.

According to this embodiment, different target image capturing units are used to detect obstacles at different water depths. This can reduce resource overheads of the cleaning device during operation and ensure a certain degree of accuracy.

In one embodiment, the method further includes: detecting water cleanliness of the target water region to determine target water cleanliness; and determining a capturing parameter of the target image capturing unit based on the target water cleanliness and capturing the image of the third obstacle based on the capturing parameter to obtain the target image data.

The water cleanliness may be obtained by using any detection device such as a water quality detection sensor, a brightness detection sensor, or the target image capturing unit. This is not limited herein.

Optionally, in this embodiment, the determining a capturing parameter of the target image capturing unit based on the target water cleanliness may be understood as that when water is turbid or clear, corresponding capturing parameters of the target image capturing unit are different.

It should be noted that the capturing parameter may be understood as exposure, a focal length, or the like. Different capturing parameters are set, so that better target image data is collected at different water cleanliness to ensure subsequent identification accuracy.

In one embodiment, the determining a capturing parameter of the target image capturing unit based on the target water cleanliness and capturing the image of the third obstacle based on the capturing parameter to obtain the target image data includes: in a case where the target water cleanliness belongs to a first cleanliness interval, configuring the capturing parameter of the target image capturing unit as a first capturing parameter and capturing the image of the third obstacle based on the first capturing parameter to obtain the target image data; and in a case where the target water cleanliness belongs to a second cleanliness interval, configuring the capturing parameter of the target image capturing unit as a second capturing parameter and capturing the image of the third obstacle based on the second capturing parameter to obtain the target image data. The first capturing parameter is a capturing parameter having a mapping relationship with the first cleanliness interval. The first cleanliness interval is different from the second cleanliness interval. The first capturing parameter is different from the second capturing parameter. The second capturing parameter is a capturing parameter having a mapping relationship with the second cleanliness interval.

In one embodiment, the identifying the target image data to determine the first identification information specifically includes: performing feature extraction on the target image data to determine target feature information of the third obstacle; and pre-processing the target feature information and inputting the pre-processed target feature information into the identification model deployed on the cleaning device to determine the first identification information. The overall target feature information includes target feature information for determining the category to which the third obstacle belongs, and pre-processing is performed to increase a weight value corresponding to the target feature information.

Optionally, in this embodiment, pre-processing is performed to weight features in the target image data to increase the weight value corresponding to the target feature information, in the overall target feature information, for determining the category to which the third obstacle belongs, so that subsequent identification accuracy corresponding to the pre-processed target feature information is higher.

For example, the pre-processing operation may include, but is not limited to, image enhancement, image denoising, image sharpening, and the like.

In one optional solution, the determining a category of the third obstacle based on the first identification information includes at least one of the following:
determining the category of the third obstacle as a first category based on the first identification information, where the target category includes a first category, and if the third obstacle belongs to the first category, it indicates that the third obstacle is an obstacle that the cleaning device needs to be away from; determining the category of the third obstacle as a second category based on the first identification information, where the target category includes the second category, and if the third obstacle belongs to the second category, it indicates that the third obstacle is a fixed obstacle; determining the category of the third obstacle as a third category based on the first identification information, where the target category includes the third category, and if the third obstacle belongs to the third category, it indicates that the third obstacle is an obstacle for which a reminder message needs to be sent; and determining the category of the third obstacle as a fourth category based on the first identification information, where the target category includes the fourth category, and if the third obstacle belongs to the fourth category, it indicates that the third obstacle is an obstacle that needs to be moved by the cleaning device.

Optionally, in this embodiment, the first category may be understood as a category of an obstacle, for example, a rag or clothing, over which a longer avoidance distance needs to be set for the cleaning device compared with avoidance distances for obstacles of other categories.

Optionally, in this embodiment, the second category may be understood as a category of an obstacle whose existence duration exceeds preset duration, for example, a ladder or a water pipe. The preset duration may be preset by a system or by a human. The existence duration may be obtained by recording time at which the obstacle is identified each time. For example, duration from earliest time at which the obstacle is identified to time at which the obstacle is most recently identified is recorded as the existence duration. Because the existence duration of the obstacle of the second category is too long, the cleaning device needs to clean surroundings of the obstacle more carefully, and a shorter avoidance distance needs to be set for the cleaning device compared with the avoidance distance for the obstacle of the first category.

In one example embodiment, a specific category of an obstacle may alternatively be directly identified based on an image. For example, an underwater ladder is identified as a fixed obstacle. After the category to which the obstacle belongs is determined based on the existence duration, when the obstacle or an obstacle similar to the obstacle is identified subsequently, the category of the obstacle is directly identified and determined based on the image without identifying the existence duration of the obstacle each time.

Optionally, in this embodiment, after the cleaning device determines that the third obstacle belongs to the third category, the cleaning device may send a reminder message to a target terminal connected to the cleaning device or play a reminder sound effect. For example, a human body is the third obstacle of the third category. When identifying the human body, the cleaning device needs to send the reminder message to the target terminal or play the reminder sound effect and avoid the human body.

Optionally, in this embodiment, the fourth category may be understood as a category of an obstacle that needs to be moved or cleaned by the cleaning device. The cleaning device may be configured with a mechanical control part, for example, a robotic arm. When the third obstacle is identified as belonging to the fourth category, the robotic arm is controlled to move the obstacle, so that a region blocked by the obstacle is cleaned. Alternatively, when the third obstacle is identified as belonging to the fourth category, the cleaning device is controlled to move to the obstacle, and the obstacle is cleaned by using the cleaning member, thereby improving the cleaning effect of the cleaning device.

In one optional solution, the controlling, in a target control manner corresponding to a target category, the cleaning device to perform a preset task in the target water region in a case where the category of the third obstacle is the target category includes at least one of the following: in a case where the category of the third obstacle is the first category, setting a first obstacle avoidance distance, where the first obstacle avoidance distance is greater than a preset initial obstacle avoidance distance of the cleaning device, and in a case where a distance between the cleaning device and the third obstacle meets the first obstacle avoidance distance, controlling the cleaning device to perform the preset task in the target water region based on the first obstacle avoidance distance; in a case where the category of the third obstacle is the second category, setting a second obstacle avoidance distance, where the second obstacle avoidance distance is less than the preset initial obstacle avoidance distance of the cleaning device, and in a case where the distance between the cleaning device and the third obstacle meets the second obstacle avoidance distance, controlling the cleaning device to perform the preset task in the target water region based on the second obstacle avoidance distance; in a case where the category of the third obstacle is the third category, marking a position at which the third obstacle is located, sending a target reminder message to the target terminal to indicate the position at which the third obstacle is located in the target water region, and performing the preset task in the target water region based on the preset initial obstacle avoidance distance of the cleaning device; and in a case where the category of the third obstacle is the fourth category, controlling the mechanical control part of the cleaning device to move the third obstacle and controlling the cleaning member or the mechanical control part of the cleaning device to clean the position at which the third obstacle is located before moving, to control the cleaning device to perform the preset task in the target water region.

Optionally, in this embodiment, the first obstacle avoidance distance may be preset based on prior knowledge or set adaptively based on a size of the identified third obstacle, that is, the first obstacle avoidance distance may be adaptively adjusted based on the size of the third obstacle.

It should be noted that the second obstacle avoidance distance may be preset based on prior knowledge or set adaptively based on the size of the identified third obstacle, that is, the second obstacle avoidance distance may be adaptively adjusted based on the size of the third obstacle.

In one embodiment, the method further includes: obtaining the target map of the target water region and position information of the third obstacle, where the cleaning device is configured to perform the preset task in the target water region based on the target map; and performing marking on the target map and updating the target map based on the position information to obtain an updated target map, to control the cleaning device to perform the preset task in the target water region based on the updated target map.

Optionally, in this embodiment, the target map of the target water region may be pre-calibrated based on a map calibration algorithm. Initially, a position of the third obstacle is not marked on the target map. When the third obstacle is identified for the first time, the position of the third obstacle needs to be marked, and the target map is updated based on the position information of the third obstacle to obtain the updated target map. When a distance between the cleaning device and a target position of the obstacle reaches a preset distance, the cleaning device is controlled to decelerate, and second identification information collected by the cleaning device in the target water region is obtained. The second identification information indicates feature information obtained by performing image identification on the third obstacle in a process of cleaning the target water region based on the updated target map. The target position of the obstacle indicates a marked position of the third obstacle in the updated target map. The category of the third obstacle is determined based on the second identification information, and in a case where the category of the third obstacle is the target category, the cleaning device is controlled to perform the preset task in the target water region based on a target obstacle avoidance distance corresponding to the target control manner. It may be understood that the updated target map may be displayed on the target terminal.

For details of a manner of constructing the target map of the target water region, refer to the foregoing related embodiments. Details are not described herein again.

The following describes this embodiment by using specific implementations. An example in which the cleaning device is a pool robot is used. The ultrasonic sensor and the target image capturing unit are disposed on the pool robot. The ultrasonic sensor may detect an obstacle. The target image capturing unit may capture an image of the obstacle. The pool robot may perform an operation in the swimming pool, for example, cleaning, disinfecting, and testing a water quality of the swimming pool. In a process in which the pool robot operates in the swimming pool, whether an obstacle is detected is determined based on the sensing information (including, but not limited to, the distance information and the angle information) collected by the ultrasonic sensor in the swimming pool. After the obstacle is detected, the target image capturing unit is controlled to capture and identify an image of the obstacle to finally control, in a corresponding control manner selected based on a category of the obstacle, the pool robot to clean the swimming pool.

In this embodiment, categories of obstacles are identified by using an AI recognition technology and a real-time machine positioning technology, and the obstacles are processed based on different categories. The obstacles are identified and categorized by using the AI recognition technology, and positions of the obstacles are updated on the map, so that different obstacle avoidance strategies are performed for the obstacles of different categories. In a cleaning process, the cleaning device collects image information within a preset range by using the target image capturing unit of the cleaning device, and then matches and identifies the collected image information by using the AI recognition technology, to identify a category of an obstacle and perform obstacle avoidance processing based on the category of the obstacle. After the obstacle is identified, position information of the obstacle is marked based on position information of the cleaning device. This function helps perform some processing actions in advance when the obstacle is cleaned for the second time. For example, when reaching the obstacle marked last time, the cleaning device decelerates in advance and confirms the information of the obstacle for the second time. This facilitates subsequent obstacle avoidance processing.

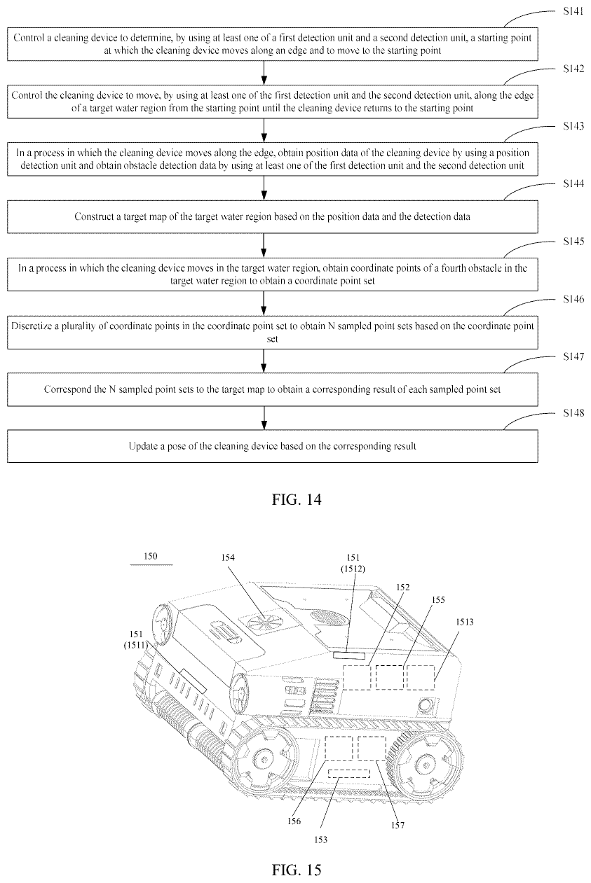

Refer to FIG. 14. FIG. 14 is a schematic flowchart of an eighth embodiment of a cleaning device control method according to this application. The method includes the following steps.

S141: Control a cleaning device to determine, by using at least one of a first detection unit and a second detection unit, a starting point at which the cleaning device moves along an edge and to move to the starting point.

S142: Control the cleaning device to move, by using at least one of the first detection unit and the second detection unit, along the edge of a target water region from the starting point until the cleaning device returns to the starting point.

S143: In a process in which the cleaning device moves along the edge, obtain position data of the cleaning device by using a position detection unit and obtain obstacle detection data by using at least one of the first detection unit and the second detection unit.

S144: Construct a target map of the target water region based on the position data and the detection data.

For specific implementation of steps S141 to S144, refer to related descriptions of the first embodiment of the cleaning device control method provided in this application. Details are not described herein again.

S145: In a process in which the cleaning device moves in the target water region, obtain coordinate points of a fourth obstacle in the target water region to obtain a coordinate point set.

The coordinate point set includes coordinate points of the actual fourth obstacle encountered by the cleaning device in a process of performing an operation. Coordinate points of the fourth obstacle in the target map are theoretical coordinate points, and may be inconsistent with the actual coordinate points of the fourth obstacle.

In one embodiment, in the process in which the cleaning device moves in the target water region, the coordinate points of the fourth obstacle in the target water region are obtained by using a target sensor, and coordinate points in a preset time window are extracted from the coordinate points of the fourth obstacle to obtain the coordinate point set. In the above embodiment, the target sensor measures the coordinate points of the fourth obstacle by using ultrasound. The target sensor may be disposed on the cleaning device or disposed in the target water region. If the target sensor is disposed on the cleaning device, at least one ultrasonic sensor may be disposed on one side portion of the cleaning device, or at least one ultrasonic sensor may be disposed on each of different side portions of the cleaning device. For example, in a case where the cleaning device is a pool robot, the target sensor is a highly waterproof ultrasonic sensor. A waterproof sealing box is disposed outside the target sensor, a probe of the sensor is exposed to water, and the remaining parts are accommodated in the waterproof sealing box. In this way, the ultrasonic sensor can be waterproof. Accuracy of obtaining the coordinate points of the fourth obstacle can be improved by using the waterproof target sensor.

S146: Discretize a plurality of coordinate points in the coordinate point set to obtain N sampled point sets based on the coordinate point set.

Each sampled point set includes a plurality of sampled coordinate points, and N is a natural number greater than or equal to one. In a case where a quantity of coordinate points in the coordinate point set is greater than a preset quantity, a rotation operation and a translation operation are performed on the coordinate point set based on a preset rotational sampling scale, a preset translational sampling scale, a preset rotational sampling range, and a preset translational sampling range to obtain the N sampled point sets. In the above embodiment, all coordinate points of the fourth obstacle within a specific time window threshold are first saved, and then whether the quantity of coordinate points of the fourth obstacle reaches a required quantity is determined. For example, if 10 coordinate points of the fourth obstacle are collected within 1 min, the quantity of coordinate points is insufficient, and the coordinate points need to continue to be collected. If 100 coordinate points are collected within 2 min, the quantity of coordinate points reaches the required quantity, and the 100 coordinate points constitute the coordinate point set. Rotation operations of different scales and translation operations of different scales are performed on the coordinate point set based on different rotational sampling ranges and different translational sampling ranges, and sampling is performed on the rotated and translated coordinate point set.

In one embodiment, after the discretizing a plurality of coordinate points in the coordinate point set to obtain N sampled point sets based on the coordinate point set, the method further includes: transforming each of the N sampled point sets from a coordinate system of the cleaning device to a world coordinate system.

S147: Correspond the N sampled point sets to the target map to obtain a corresponding result of each sampled point set.

In one embodiment, any one sampled point set (namely, a target sampled point set) in the N sampled point sets is used as an example. Any sampled coordinate point in the target sampled point set corresponds to the target map. Whether the fourth obstacle is located at a position indicated by a coordinate point in the target map corresponding to the sampled coordinate point is determined to obtain the corresponding result. Specifically, for any point in each target sampled point set, whether the fourth obstacle is located at a position in the target map corresponding to a sampled point is calculated. If the fourth obstacle is located at the position in the target map corresponding to the sampled point, a score of the target sampled point set is increased by 1. Otherwise, the score of the target sampled point set remains unchanged. In this way, a target sampled point set with a highest score can be calculated.

S148: Update a pose of the cleaning device based on the corresponding result.

In one embodiment, when the fourth obstacle is located at a position indicated by a coordinate point in the target map corresponding to any sampled coordinate point in the target sampled point set, a score of the target sampled point set is accumulated. When the score of the target sampled point set is greater than a preset score, a rotational sampling scale (namely, a target rotation scale) and a translational sampling scale (namely, a target translation scale) of the target sampled point set are determined. The pose of the cleaning device is updated based on the target rotation scale and the target translation scale. In this embodiment, the target sampled point set with the highest score may be used as a position reference, and the target rotation scale and the target translation scale may be applied to a current moving position of the cleaning device, that is, a rotation operation and a translation operation are performed on the current moving position of the cleaning device based on the target rotation scale and the target translation scale, to update the pose of the cleaning device, complete real-time positioning of the cleaning device in a current period, and enter a next observation period. In this way, the pose of the cleaning device and the target map can be updated in real time.

In the above method, the collected coordinate point set of the fourth obstacle is discretized, sampling is performed on the discretized coordinate point set, and the target map is optimized by using the sampled point sets, so that the cleaning device can move in the target water region based on an optimized target map. In this way, problems of inaccurate positioning of an automatic moving device in a water region in a related technology and a low accuracy rate of pose updating can be resolved, and an accuracy rate of positioning of the automatic moving device in the water region can be effectively improved.

In one embodiment, after the updating a pose of the cleaning device based on the corresponding result, the method further includes: constructing an optimized target map of the target water region based on the updated pose of the cleaning device. In this embodiment, the target map constructed based on the updated pose of the cleaning device is more accurate.

Refer to FIG. 15. FIG. 15 is a schematic structural diagram of a cleaning device according to an embodiment of this application.

The cleaning device 150 includes a detection unit 151, a mode switching member 152, at least one water inlet 153, at least one water outlet 154, and a filtering unit 155 at least partially disposed inside the cleaning device. The detection unit 151 includes at least a first detection unit 1511 disposed on a front portion, a second detection unit 1512 disposed on a side portion, and a position detection unit 1513. The first detection unit 1511 and the second detection unit 1512 are configured to detect information of obstacles in different directions of the cleaning device 150. The position detection unit 1513 is configured to determine a position of the cleaning device 150. Each of the first detection unit 1511 and the second detection unit 1512 may be a distance measurement sensor. The position detection unit 1513 can detect a current position of the cleaning device 150, for example, a detection unit for detecting depth information. The filtering unit 155 is configured to filter debris in the target water region. The position detection unit 1513 may alternatively be disposed on a position on the cleaning device 150 other than the side portion of the cleaning device 150, for example, the inside, the top, the front portion, a rear portion, or the bottom of the cleaning device 150. This is not limited herein.

The cleaning device 150 further includes a memory 156 and a processor 157. The memory 156 stores program instructions. The processor 157 is configured to execute the program instructions stored in the memory 156 to implement the steps in any of the above method embodiments. In one specific implementation scenario, the cleaning device 150 may include a microcomputer, and a server. This is not limited herein.

Specifically, the processor 157 is configured to control itself and the memory 156 to implement the steps in any of the above method embodiments. The processor 157 may also be referred to as a central processing unit (Central Processing Unit, CPU). The processor 157 may be an integrated circuit chip and has a signal processing capability. The processor 157 may alternatively be a general-purpose processor, a digital signal processor (Digital Signal Processor, DSP), an application-specific integrated circuit (Application-Specific Integrated Circuit, ASIC), a field-programmable gate array (Field-Programmable Gate Array, FPGA) or another programmable logic device, a discrete gate, a transistor logic device, or a discrete hardware component. The general-purpose processor may be a microprocessor, or the processor may be any conventional processor or the like. In addition, the processor 157 may be implemented by an integrated circuit chip.

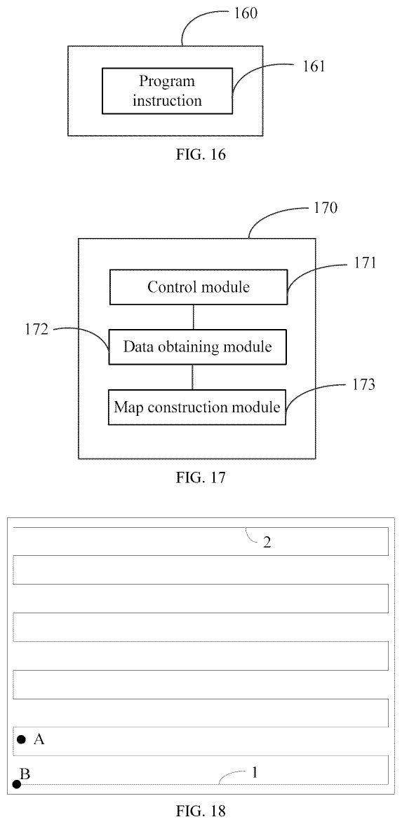

Refer to FIG. 16. FIG. 16 is a schematic diagram of a frame structure of a computer-readable storage medium according to an embodiment of this application.

The computer-readable storage medium 160 stores program instructions 161. When the program instructions 161 are executed by a processor, the steps in any of the above method embodiments are implemented.

The computer-readable storage medium 160 may be specifically any medium that can store a computer program, such as a USB flash drive, a removable hard disk, a read-only memory (ROM, Read-Only Memory), a random access memory (RAM, Random Access Memory), a magnetic disk, or an optical disc, or may be a server storing the computer program. The server may send the stored computer program to another device to run the computer program, or the server may run the stored computer program.

Refer to FIG. 17. FIG. 17 is a schematic diagram of a frame structure of a cleaning device control apparatus according to an embodiment of this application.

The cleaning device control apparatus 170 includes a control module 171, a data obtaining module 172, and a map construction module 173. The control module 171 is configured to: control a cleaning device to determine, by using at least one of a first detection unit and a second detection unit, a starting point at which the cleaning device moves along an edge and to move to the starting point, and control the cleaning device to move, by using at least one of the first detection unit and the second detection unit, along the edge of a target water region from the starting point until the cleaning device returns to the starting point. The control module 171 is further configured to control a distance between the cleaning device and a wall of the target water region to be less than a preset distance in a process of moving along the edge. The data obtaining module 172 is configured to: in the process in which the cleaning device moves along the edge, obtain position data of the cleaning device by using a position detection unit and obtain obstacle detection data by using at least one of the first detection unit and the second detection unit. The map construction module 173 is configured to construct a target map of the target water region based on the position data and the detection data. The target map includes a map of at least one of the bottom, the wall, and a water surface of the target water region.

In one embodiment, the control module 171 is further configured to control the cleaning device to rotate, perform a target operation, move, and the like. Any action change of the cleaning device may be controlled by the control module 171.

In one embodiment, the map construction module 173 is further configured to: construct a three-dimensional map of the target water region based on depth data obtained by using a depth detection unit, a target map of the bottom of the target water region, and a target map of the water surface; construct a target map model based on the target map, where the target map model includes a bottom model, a wall model, and a water surface model of the target water region; and construct a three-dimensional rendered map of the target water region based on the bottom model, the wall model, and the water surface model of the target water region.

In one embodiment, the cleaning device control apparatus 170 further includes a path planning module. The path planning module is configured to perform path planning on the target water region based on the target map. The control module 171 can control the cleaning device to move along a cleaning path and to clean the target water region during moving.

If the technical solutions of this application involve personal information, before the product to which the technical solutions of this application are applied processes the personal information, an individual has been clearly informed of a personal information handling rule, and the individual has autonomously consented. If the technical solutions of this application involve sensitive personal information, before the product to which the technical solutions of this application are applied processes the sensitive personal information, the individual has separately consented, and a requirement of “express consent” is also met. For example, at a personal information collection apparatus such as a camera, a clear and conspicuous sign is set to inform that an individual has entered a personal information collection scope, personal information is to be collected, and if the individual voluntarily enters the collection scope, it indicates that the individual agrees about collection of his/her personal information; or in a case where the personal information processing rule is informed by using an obvious sign/information at a personal information processing apparatus, individual authorization is obtained by using pop-up information, asking the individual to upload his/her personal information by himself/herself, or the like. The personal information processing rule may include information, for example, a personal information processor, a personal information processing purpose, a processing manner, and types of processed personal information.

The above description describes only embodiments of this application and is not intended to limit the scope of this application. Any equivalent structure or equivalent process transformation performed based on contents of the specification and the accompanying drawings of this application or applied directly or indirectly in other related technical fields shall fall within the protection scope of this application.

What is claimed is:

1. A method for controlling a cleaning device to clean a wall, wherein the cleaning device moves in a target water region, and the method comprises:
when the cleaning device cleans a first wall of the target water region, controlling the cleaning device to perform cleaning along a first cleaning path;
controlling the cleaning device to move along the first cleaning path for a first target preset distance in a first direction or a second direction to a path switching position, wherein the first direction is a direction from the bottom of the target water region to a water surface of the target water region, and the second direction is a direction from the water surface of the target water region to the bottom of the target water region;
controlling the cleaning device to move from the path switching position along a third path for preset duration or a second target preset distance to a starting position of a second cleaning path; and
controlling the cleaning device to move along the second cleaning path in the first direction or the second direction to perform cleaning along the second cleaning path, wherein
the third path is different from the first cleaning path, the second cleaning path is different from the first cleaning path and the third path, the second cleaning path is substantially parallel to the first cleaning path, the path switching position is a starting position at which the first cleaning path is switched to the second cleaning path, and the path switching position is away from the bottom of the first wall and a waterline of the target water region.

2. The method according to claim 1, wherein the controlling the cleaning device to perform cleaning along a first cleaning path comprises:
controlling the cleaning device to perform cleaning along the first cleaning path in the first direction from the bottom of the target water region or the bottom of the first wall; or
controlling the cleaning device to perform cleaning along the first cleaning path in the second direction from the waterline of the target water region or the top of the first wall.

3. The method according to claim 1, wherein the controlling the cleaning device to move along the second cleaning path in the first direction or the second direction to perform cleaning along the second cleaning path comprises:
controlling the cleaning device to move from the starting position of the second cleaning path along the second cleaning path in the first direction or the second direction to perform cleaning along the second cleaning path, wherein a direction in which the cleaning device moves from the starting position of the second cleaning path along the second cleaning path is the same as or opposite to a direction in which the cleaning device moves along the first cleaning path to the path switching position.

4. The method according to claim 3, wherein the controlling the cleaning device to move along the first cleaning path for a first target preset distance in a first direction or a second direction to a path switching position comprises:
controlling the cleaning device to move from the bottom of the target water region or the bottom of the first wall in the first direction to the path switching position; and
the controlling the cleaning device to move from the starting position of the second cleaning path along the second cleaning path in the first direction or the second direction to perform cleaning along the second cleaning path comprises:
controlling the cleaning device to first move from the starting position of the second cleaning path along the second cleaning path in the first direction to perform cleaning, or to first move from the starting position of the second cleaning path along the second cleaning path in the second direction to perform cleaning.

5. The method according to claim 3, wherein the controlling the cleaning device to move along the first cleaning path for a first target preset distance in a first direction or a second direction to a path switching position comprises:
controlling the cleaning device to move from the waterline of the target water region or the top of the first wall in the second direction to the path switching position; and
the controlling the cleaning device to move from the starting position of the second cleaning path along the second cleaning path in the first direction or the second direction to perform cleaning along the second cleaning path comprises:
controlling the cleaning device to first move from the starting position of the second cleaning path along the second cleaning path in the second direction to perform cleaning, or to first move from the starting position of the second cleaning path along the second cleaning path in the first direction to perform cleaning.

6. The method according to claim 1, wherein before the cleaning device reaches the path switching position for path switching, the cleaning device traverses the first cleaning path at least once, or before the cleaning device reaches the path switching position for path switching, the cleaning device cleans the path switching position at least once.

7. The method according to claim 6, wherein before the cleaning device moves from the bottom of the target water region or the bottom of the first wall in the first direction to the path switching position for path switching, the cleaning device completes moving from in the first direction to the second direction at the waterline of the target water region at least once.

8. The method according to claim 6, wherein before the cleaning device moves from the waterline of the target water region or the top of the first wall in the second direction to the path switching position for path switching, the cleaning device completes moving from in the second direction to the first direction at the bottom of the target water region or the bottom of the first wall at least once.

9. The method according to claim 1, wherein the controlling the cleaning device to move from the path switching position along a third path for preset duration or a second target preset distance to a starting position of a second cleaning path comprises:
controlling the cleaning device to adjust a moving direction and move to the starting position of the second cleaning path; or
controlling the cleaning device to translate to the starting position of the second cleaning path.

10. The method according to claim 1, wherein after the cleaning device moves to the starting position of the second cleaning path, the method further comprises: adjusting a moving direction of the cleaning device, causing the cleaning device to perform cleaning along the second cleaning path in the first direction or the second direction.

11. The method according to claim 1, wherein the first cleaning path at least partially overlaps with the second cleaning path.

12. The method according to claim 1, wherein when moving in the first direction and the second direction, the cleaning device remains substantially the same posture, or the cleaning device moves backward in the second direction.

13. The method according to claim 1, wherein when there is an obstacle on the first cleaning path, the cleaning device is controlled to perform an obstacle avoidance action.

14. The method according to claim 13, wherein the obstacle avoidance action comprises:
when the cleaning device detects that there is an obstacle in a current moving direction, the cleaning device moves in a direction opposite to the current moving direction; or
when the cleaning device detects that there is an obstacle on the first cleaning path, the cleaning device is switched to move along the second cleaning path.

15. The method according to claim 14, further comprising: after the cleaning device is switched to move along the second cleaning path and performs cleaning for a preset distance, switching the cleaning device to move along the first cleaning path again to perform cleaning.

16. The method according to claim 1, further comprising:
controlling the cleaning device to move from the first wall to a second wall adjacent to the first wall; and
after the cleaning device moves to the second wall, controlling the cleaning device to clean the second wall against a coincidence line of the first wall and the second wall at least once.

17. The method according to claim 16, wherein the controlling the cleaning device to move from the first wall to a second wall adjacent to the first wall comprises:
controlling the cleaning device to move from the first wall to the bottom of the target water region, and after the cleaning device reaches the bottom of the target water region, controlling the cleaning device to move from the bottom of the target water region to the second wall; or
controlling the cleaning device to move from the first wall to the second wall via the coincidence line; or
controlling the cleaning device to move from the first wall to the water surface of the target water region, and after the cleaning device reaches the water surface of the target water region, controlling the cleaning device to move from the water surface to the second wall.
